(19) United States
(12) Patent Application Publication
(10) Pub. No.: US 2007/0162308 A1
(43) Pub. Date: Jul. 12, 2007

(54) System and methods for performing distributed transactions

(76) Inventor: James D. Peters, Alpharetta, GA (US)

Correspondence Address: MCGUIREWOODS, LLP, 1750 TYSONS BLVD, SUITE 1800, MCLEAN, VA, 22102, US

(21) Appl. No.: 11/652,096

(22) Filed: Jan. 11, 2007

Related U.S. Application Data
(60) Provisional application No. 60/758,325, filed on Jan. 11, 2006.
(60) Provisional application No. 60/758,395, filed on Jan. 11, 2006.
(60) Provisional application No. 60/758,433, filed on Jan. 11, 2006.
(60) Provisional application No. 60/758,283, filed on Jan. 11, 2006.

(51) Int. Cl. G06Q 10/00; G06Q 40/00; G06F 7/00

(52) U.S. Cl. 705/2; 705/4; 707/101

(57) ABSTRACT

A system and methods is described for providing unified and secure centralizing information management to permit interoperability of disparate stakeholders in the healthcare industry access and update information under a common scheme thereby creating a more efficient delivery system for all the stakeholders such as patients, doctors, clinics, hospitals, insurance companies, pharmacies and related healthcare entities.

### CROSS REFERENCE TO RELATED APPLICATIONS

This application claims the benefit of U.S. Provisional Patent Application No. 60/758,325, U.S. Provisional Patent Application No. 60/758,395, U.S. Provisional Patent Application No. 60/758,433 and U.S. Provisional Patent Application No. 60/758,283, each of which were filed on Jan. 11, 2006, and are incorporated by reference herein, in their entirety. Further, this application is related to U.S. patent application Ser. No. ______, entitled “TOOLBAR USER INTERFACE FOR INFORMATION SYSTEM,” U.S. patent Application Ser. No. ______, entitled “SYSTEM AND METHOD FOR A SECURE PROCESS TO PERFORM DISTRIBUTED TRANSACTIONS,” and U.S. patent application Ser. No. ______, entitled “SYSTEM AND METHODS FOR PERFORMING DISTRIBUTED PAYMENT TRANSACTIONS,” each of which are being filed simultaneously herewith, having James D. Peters as a common inventor, and are incorporated by reference herein, in their entirety.

### BACKGROUND OF THE INVENTION

1. Field of Invention

This invention relates generally to extending business interoperability to business entities, and, more particularly, to a system and process for efficiently extending interoperability for communications and data related to transactions to business entities in an overall business sector, such as healthcare.

2. Related Art

Generally, the issues facing the healthcare industry include the continuing need for efficiency in each of the industry market verticals (“Vertical (s)”) such as clinics, hospitals, insurance payers, etc. and (b) the lack of effectiveness for transactions that occur across these vertical segments, affecting the entire healthcare market sector (“Sector”, or “Horizontal”.) The ability to effectively conduct business electronically, across and between these Verticals in the entire healthcare Sector is referred to as interoperability. Whereas solutions from various companies exist that attempt to make the Verticals more efficient, there is no solution in the marketplace that makes the overall market sector effective. Generally, efficiently means to do things right; effectively means to do the right things.

Looking into each of the two issues identified above we note:

(a) Regarding the Vertical market segments, many companies have and continue to invest their resources and energies in making the Verticals more efficient through automation. This process is by no means complete, but the various market competitors continue to improve their products to deliver higher process efficiencies in each of these market segments. Examples of such companies are NextGen, GE Healthcare, Greenway Technologies, eClinicalWorks, Allscripts and others who have developed and market software solutions that increase the efficiency of clinics and medical offices. Similarly, corporations such as CERNER, SMS, McKesson and others have developed and market solutions that make hospitals more efficient. Others have done the same for other industry Verticals that contribute to the healthcare process, such as the insurance segment, the banking segment, the pharmacy segment, etc.

The lack of efficiency in the Vertical segments has been reviewed by the Institute of Medicine in the Untied States. On Mar. 1, 2001, the Institute of Medicine issued a report entitled Crossing the Chasm: A New Health System for the 21st Century that clearly describes the state of the healthcare industry in the United States. Specifically, this report states that the healthcare industry is in dire need of automation in all its operations, including hospitals, clinics and doctors in their practices (“Healthcare Providers”). This lack of automation causes healthcare to be expensive and inefficient, and it impedes the ability of healthcare providers to share electronically patient data, clinical and payment information. Such inefficiencies result not only in lost earnings (for example, it is estimated that in many cases as much as thirty percent (30%) of insurance claims are not paid because they cannot be processed due to improper coding), but also in exposure to potential legal liability that causes related insurance premiums to remain very high.

Furthermore, a federal statute governing the use of healthcare information, the Health Insurance Portability and Accountability Act of 1996, known as HIPAA, imposes federal requirements that affect healthcare providers and other covered entities. The regulations implementing HIPAA mandate certain changes that all healthcare providers must effect in their operations.

(b) The present lack of Interoperability can be illustrated by the following quote from independent and credible third-party. The Health and Human Services (HHS) Secretary in 2006 said: “The U.S. health care system needs an interoperable electronic health records and billing system . . . I've come to conclude there really isn't a health care system. There's a health care sector . . . There's really nothing that connects it together into an economic system.”

Regarding the effectiveness of conducting business across the overall Sector, we note that there are numerous “Stakeholders” in the Healthcare Sector, including: Patients; Hospitals (including Urgent Care); Primary Physicians; Specialist Physicians; Pharmacies; Insurance Payers; Laboratories (for various tests, imaging, pulmonary, cardio, etc.); Pharmaceutical Companies; Banks that handle transaction payments including HAS/FSA accounts; Clearing Houses that negotiate a discounted network of services; Employers who participate in the payment of insurance premiums; Government that regulates and insures; and Associations that act as volume purchasing groups, such as Independent Physician Associations and Unions. Generally, a “Stakeholder” may be an individual, or corporation or other type of business who derives a business or personal benefit of any kind, and/or who contributes or participates in the delivery of healthcare services.

Whereas many companies are working hard to make each of these Stakeholders efficient (Verticals), there is no other solution in the marketplace that make the Horizontal processes effective (that is to say across the entire Healthcare Sector), at this time, nor is there a common infrastructure over which these stakeholders can conduct business effectively, in an automated way. In fact, it has been estimated that over 90% of some 30 billion healthcare transactions per year in the USA are paper based.

Moreover, there is a general mistrust among the key stakeholders, which is more or less natural in a market that is fraught with errors, fraud, inefficiency and shrinking margins. For example, in 2006, the head of the U.S. Department of Health and Human Services (HHS) has stated that in his estimate, that up to 25% of all Medicare transactions may be fraudulent.

This conflict is one of the main reasons why the various Stakeholders in healthcare do not collaborate, and hence the result is a disjointed, semi-automated and expensive healthcare delivery system, as illustrated in FIG. 1A, where some of the Stakeholders are shown illustratively as pieces of a disjointed puzzle. I.e., there is no common infrastructure among Stakeholders. Furthermore, because collaboration is important but not mandatory for effectiveness, it is difficult for anyone of the major players to play a leading role, due to objections by their competitors. For example, if a first large insurance company would take an initiative to resolve some of the key industry problems, why would a second insurance company collaborate and risk losing market share? The answer is likely they would not. It becomes obvious that the marketplace would favor an independent party, especially one that offers advantages to each of the healthcare stakeholders.

It should be noted that parts of the effectiveness solution are being addressed by initiatives that are typically sponsored by various States of the Union and referred to as Regional Health Information Organizations (“RHIO”), such RHIOs are generally concerned with and attempt to provide a standard with which to electronically share medical records with care providers, such as hospitals, clinics and physicians. In this RHIO environment, the participating Stakeholders are limited to healthcare providing entities, and the type of information they share is limited to medical records. But, this fails to address the needs of all types of Stakeholders, in all of the various products and services they require, including medical records. Examples of the additional products and services addressed by this invention include but are not limited to: Records and benefits individuals (and their families) derive from their membership in Associations; employment data, including detailed healthcare benefits; records and access to banking products of the individuals for healthcare related accounts, such as Health Savings Accounts and other financial matters, such as records for healthcare tax exemptions; records of medications individuals have been prescribed for and other related issues, such as whether they have purchased their medication, etc.

### SUMMARY OF THE INVENTION

The invention satisfies the foregoing needs and avoids the drawbacks and limitations of the prior art by providing a system and methods for the providing interoperability among various stakeholders in the healthcare industry to provide efficient and timely processing of information to delivery effective healthcare.

An aspect of the invention includes a system for providing interoperability between stakeholders in the healthcare industry including a logically centralized database having information records related to a plurality of different stakeholders, wherein each stakeholder is a member of at least one category of stakeholders include at least a patient member, a medical provider and an insurance company, a plurality of disparate medical records systems each provided by a different vendor and having different internal formats of data and at least one integration component interfaced with each of the plurality of disparate medical records systems to normalize the information in each disparate medical records system and to permit access to the normalized information by the different stakeholders.

Another aspect of the invention includes a method of providing interoperability for different types of stakeholders in the healthcare industry. The steps include identifying a type of stakeholder, determining a need of the stakeholder, identifying a software component to satisfy the need of the stakeholder based on the type of stakeholder, integrating the identified software component with a medical records system associated with the stakeholder and exchanging data using the integrated software component by converting information in one format into a different format for access by another stakeholder to deliver a healthcare related transaction.

Another aspect of the invention includes a method for providing interoperability in the healthcare industry that includes a system comprising a logically centralized database having information records related to a plurality of different stakeholders, wherein each stakeholder is a member of at least one category of stakeholders include at least a patient member, a medical provider and an insurance company, a plurality of disparate medical records systems each provided by a different vendor and having different internal formats of data, at least one integration component interfaced with each of the plurality of disparate medical records systems to normalize the information in each disparate medical records system and to permit access to the normalized information by the different stakeholders, the method includes the steps of querying the logically centralized database by a first stakeholder, receiving a response from the centralized database that provides information concerning at least a second stakeholder, and completing a healthcare related transaction based on the response.

Additional features, advantages and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention. In more detail than may be necessary for a fundamental understanding of the invention and the various ways in which it may be practiced. In the drawings:

FIG. 1 is an illustration showing no common infrastructure among stakeholders;

FIG. 1B is an illustration showing interoperability among stakeholders provided by the invention;

FIG. 2 is a block diagram showing an exemplary architecture and environment of the invention;

FIGS. 3A-3F are logical representations of data organization, according to principles of the invention;

FIGS. 4A and 4B illustrate the stakeholder processes before and after, respectively, the functional contributions of the invention;

FIG. 5A is a block diagram illustratively showing aspects of the invention being installed on a client system;

FIG. 5B is an illustration showing a typical existing medical office arrangement, prior to the invention;

FIG. 5C is an illustration showing a typical medical office arrangement, according to principles of the invention;

FIGS. 6A-6E are flow diagrams showing steps of providing aspects the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

A conceptual view may be taken that the healthcare system may be or could be somewhat analogous to the credit card system. In a credit card system, a consumer receives products and services from a merchant who uses a network (such as VISA) to go to the payer (e.g., the Bank) and receive payment. Similarly, a patient goes to a physician for services, the physician is linked through some clearing house and PPO or HMO network to the payer (the Insurance.) From a technology point of view, both systems are structured somewhat similarly. Even though healthcare is twice as large in annual volume of dollars transacted per year ($2 trillion) it is not even near the level of efficiency that the credit card system enjoys, where payments are performed in near real-time.

Employers (especially if they are self-insured) are under pressure to reduce expenses, and thus they are open to review products and services that are likely to decrease their expenses at a fraction of the cost. The savings potential to an employer could be as much as 30% reduction in the cost of the healthcare benefits. Thus, employers would likely be motivated to use a system such as EON.

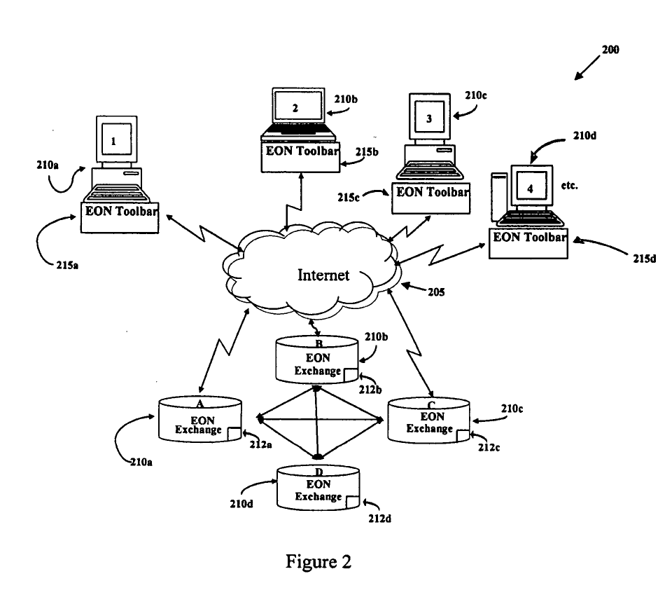

As explained more below, as an illustrative example, once employees are registered in the EON Exchange (Stakeholders in the healthcare market sector may be served through the invention through a common set of middleware software referred to as the EON Exchange 210a-210d, as illustrated in FIG. 2 and described below, where the disjointed healthcare sector obtains interoperability through techniques such as common access, integration, and data warehouse), then they can receive as patients medical care anywhere at any time, so long as there is an Internet access (under patient controlled password) to the patient's medical chart that resides in a secure database that could be managed as an outsourced service, such as in the EON Exchange. In this manner, the patient no longer needs to fill-in the infamous clipboard at the time of registration, but can be updated beforehand on-line by a patient, and/or accessed by a doctor in real-time during treatment. Once physicians realize the advantages of using the functionality provided by the invention for the employee and how they can (for a small transaction fee) conduct their own business much more efficiently, profitability should rise.

There are approximately two and a half thousand hospitals (2,500) one hundred twenty five thousand (125,000) clinics and eight hundred fifty thousand (850,000) doctors in the United States. These providers currently attempt to meet their information processing needs by using multiple software programs that usually provide only partial and incomplete solutions. The EON Exchange is designed with an advanced systems architecture that enables an enterprise-wide solution to operate either on a stand alone “client-server” basis or as an internet based ASP service, and in a secure way. The EON Exchange is flexible, expandable for volume, can operate multiple provider sites/facilities as departments of one organization and can be changed or modified in days, versus months for PC based systems and years for Legacy Systems. By design, the EON Exchange is capable of running on any intelligent computer operating system, or as a network-based service. The EON Exchange system can be used together with or separately from the EON Toolbar system.

A partial list of the advantages provided by the invention is as follows:
Patient care can be delivered anywhere, anytime, securely to authorized users through various delivery tools, such as the Internet; removable “thumb drive” disks; TV screens; iPods, etc. or even by simply calling a central Help Desk where operators can relay (upon positive authentication of the identity of the caller) certain portions of the person's medical record as needed for urgent care. Prior to the invention, electronic medical record systems are not interoperable. The invention transforms this, so, typically regardless of the systems and technology in use, and thus the advantages mentioned above are obtained.
Patients or Members are able to obtain additional information that present day Electronic Medical record Systems do not provide, such as (but not limited to): personal health baseline (screening data) captured earlier or during the enrollment process; real time review of medications purchased; real time comparison of prices of brand name and generic drugs; review of past medical history while at home, either from an Internet connected PC, a PDA, a digital Blue Tooth wireless telephone, the TV screen; and other personal information, as has been previously been authorized; etc.
Patients or members of an association are uniquely identified through biometric information that is maintained in the EON Exchange, but is captured through the EON Toolbar during the enrollment process of patients or members.
All Stakeholders receive timely and accurate information on the data they are authorized to obtain.
Accurate and secure records are maintained of all data that are important to all Stakeholders.
All Stakeholders can exchange and share authorized information, securely, regardless of the technology and systems they use to store their data.
Patients or patient members can obtain through the Internet their own healthcare related financial records and attach them to their tax return.
Patients can access and can authorize providers to access and debit their own personal HSA and FSA health related financial accounts, with appropriate record keeping and tracking.
Medical providers (hospitals, clinics, physicians, assistants) can obtain near real time insurance verification and predetermination of what the insurance will cover, and how much will be reimbursed by the Insurance carrier and what is the patient's financial responsibility, while the patient is present and is being discharged.
All payments that are due as a result of services rendered by any of the Stakeholders to other Stakeholders can occur in seconds, securely, accurately, on a real time (“7-24”) basis.
Providers that use the EON System can consolidate their back office.

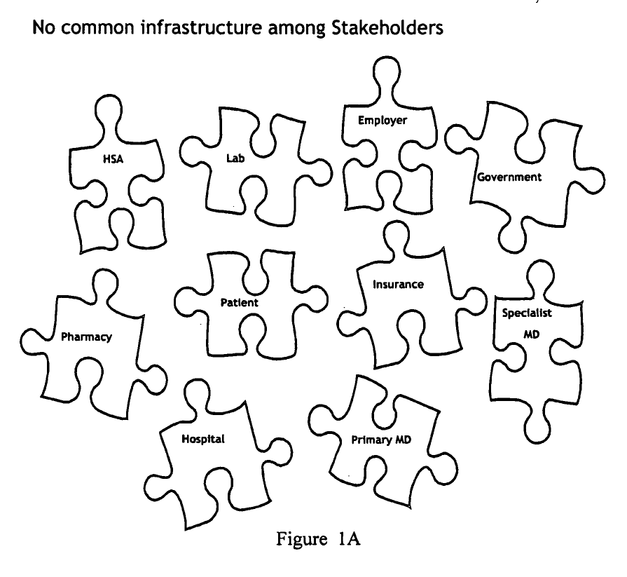

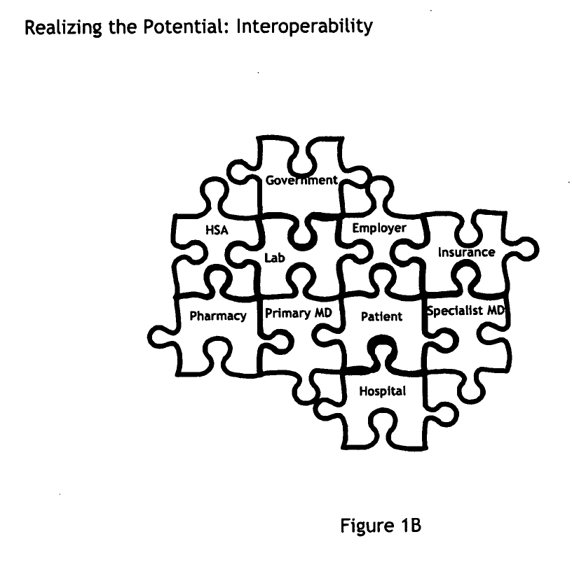

The invention offers a flexible, scaleable, secure, efficient and comprehensive suite of integrated and patient centric products and services (solutions) that run on any suitable hardware and can use the Internet to address the totality of needs of patients, members, doctor practices, clinics, employers, and other categories of Stakeholders in the healthcare market sector. Logically, the invention unifies all the stakeholders as illustrated in FIG. 1B.

FIG. 2 is a block diagram showing an exemplary configuration of various components of the invention, generally denoted by reference numeral 200. The invention 200 typically utilizes the Internet 205 as a telecommunications vehicle, or direct telecommunications lines (such as Virtual Private networks) as dictated by the economics of volume.

Access devices 210a-210d which may be various computer servers, lap tops, personal desk top computers, PDAs, etc., having various operating systems, from companies such as Microsoft, Linux, and Apple, for example, permitting users to gain access to the system. To each of such access devices, the EON Toolbar 215a-215b may be down-loaded from the EON Exchange 210 through the Internet 205 as explained in more detail in co-pending U.S. patent application Ser. No. ______, entitled “System and Method for a User Interface for Performing Distributed Transactions.” The toolbar 215 is adaptable so that the displays and content of information are altered based on the identity of the stakeholder using the toolbar 215.

The system of the invention includes one or more software components 210a-210d, referred to generally as the EON Exchange. Although the EON Exchange 210 may be different “nodes,” they are part of one logical system. Physically the nodes could be located in facilities many miles distant from one another, and are able to operate independently, in parallel or as a back up to one another. The EON Exchange nodes may be implemented as servers and each typically includes a database 212, such as a SQL database, for example. Peer-to-peer operability may be employed to maintain real-time updates and mirrored imaging of the databases 212, as necessary.

The toolbar 215 may operate independently from the EON Exchange 210, with one another, and can synchronize their data either at the same instant in time or at various intervals of time, as design parameters, including economics, would dictate. The toolbar is adaptable in operation to conform to the user's identity and functional requirements. For example, a patient using the toolbar would be able to view and access information related only to that patient and prevented from accessing or viewing data not related to the patient (such as a clinic's data). For a clinic's user, the toolbar conforms to the user's identity and presents fields and formats appropriate to the clinic's data while shielding information unrelated to the clinic from the user.

The logical architecture of the EON Exchange database may be represented by an object having “n” dimensions and may be created and stored in database 212, typically as a relational database. Each of the “n” sides of that object represents a separate domain of data. Some examples of such data domains are: a domain for providers who are independent physicians; a domain for clinics, with multiple physicians in various medical specialties; another domain could be for general hospitals; another for urgent care hospitals; yet another for employers; another for employees; another for associations; another for private insurance plans; another for Medicare plans; another for banking; another for pharmacies, another for tax tables (federal separate from each State, and similar types of data domains associated or found in operation with the healthcare industry.

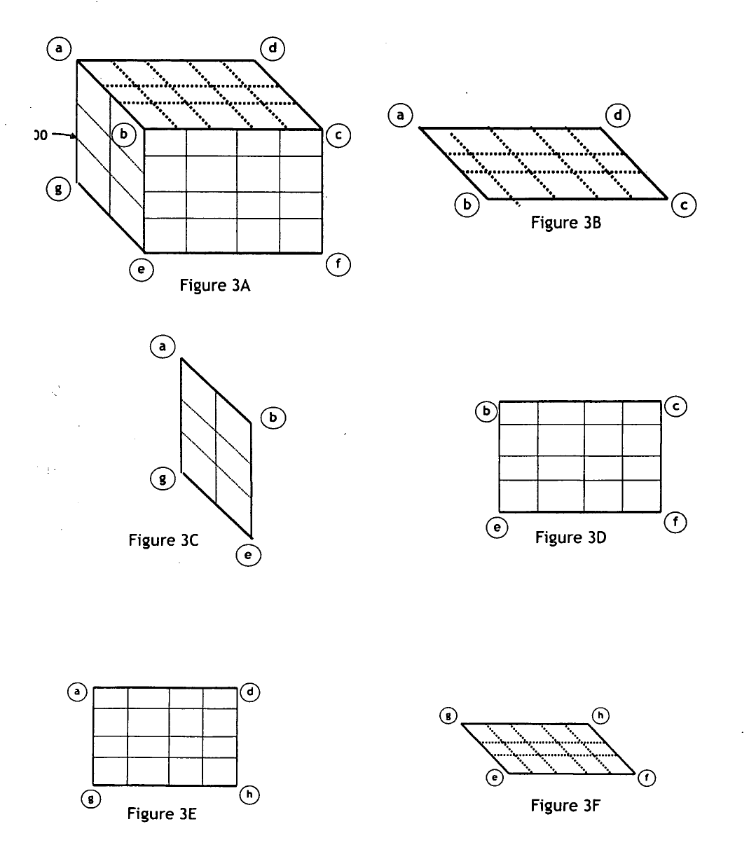

Such an “n” dimensional object is difficult to present visually on two-dimensional paper, however, aspects of the multi-dimensional object is shown illustratively in FIG. 3A in the shape of a cube, and generally designated by reference numeral 300.

As an illustrative example, assume that one side of this cubical object 300, as shown in FIG. 3B and designated by the letters a-b-c-d, represents the domain for computational algorithms. Each rectangular square (referred to as “Grid Rectangle”) in that side (a-b-c-d) corresponds to a different algorithm. As one of many possible examples, a computational algorithm may be the calculation of the patient responsibility amount of a given claim, based upon the cumulative value of the total claims submitted to date for a given group of networked coverage; another example of an algorithm may be the tracking of max-min readings of test results for a specific medical condition, accompanied by certain actions that vary upon the value of the actual test results, and so on.

In a similar fashion, assume that on the side represented by the letters a-b-e-g in FIG. 3C the domain for clinics are located. Each Grid Rectangle in that side corresponds to a different clinic, for which clinic, a set of unique data would apply. For example, the Universal ID numbers for each of the doctors in one clinic would be different from those of the doctors in another clinic, and so on.

Yet again, the side represented by the letters b-c-f-e in FIG. 3D denotes the domain for private insurance companies. For example one Grid Rectangle might represent the negotiated contract for one clinic with a private insurance carrier and then another Grid Rectangle might represent a different contract that has been negotiated by the same insurance carrier with another clinic, and so on.

Moreover, in FIG. 3E, the area marked by the letters a-d-h-g denotes another side of the illustrative cubic shape, and that side represents all the patients. Each Grid Rectangle in that side would represent different data for each patient, such as their personal demographic data; their family data in another; their individual medical records in yet another, and so on.

The other side, side e-f-h-g, of the illustrative cubic object in FIG. 3F could represent employer data, such that each Grid Rectangle of that side could be the benefit health plans for employees, which may be different from those of their family members in another Grid Rectangle, or workman compensation cases in yet another Grid Rectangle, and so on.

In this example, a given Grid Rectangle in FIG. 3E may relate to a specific issue regard to a patient, which in turn would link with another Grid Rectangle in FIG. 3F that identifies specifics to do with the employer of that patient, then they link to another specific Grid Rectangle that identifies a specific clinic that provided care depicted in FIG. 3C, and which care was covered by specific conditions of the insurance carrier as per a specific Grid Rectangle in sub-diagram 230 and they in turn may link to another specific Grid Rectangle that identifies the applicable payment algorithm in the sub-diagram 210.

Thus in this example, all the Stakeholders are linked to specific services and create unique linkages that are then computing the correct value of a given algorithm, which then is processed and recorded in the database of EON Exchange. In this manner, the separation and differentiation provided by the grid concept (and implemented in a database such as for example, an SQL database, and/or MUMPS (Massachusetts General Hospital Utility Multi-Programming System), provides intrinsic security by preventing certain entities from accessing data or information that they cannot gain access while gaining access to information that they are granted access. For example, a doctor's office could not gain access to a patient's employee related information associated with an employer.

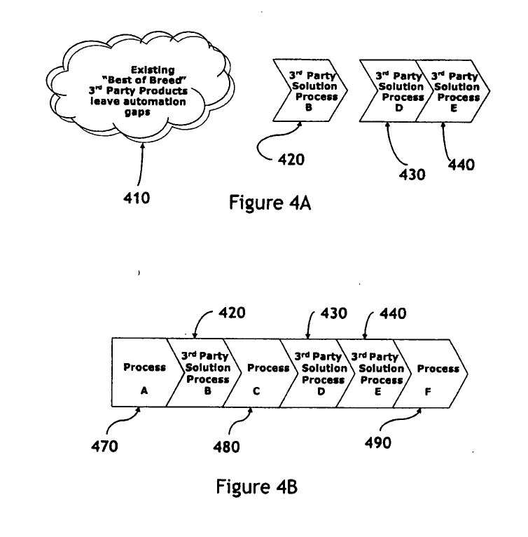

However, the invention also provides features to already existing commercial healthcare products for the purpose of re-engineering of the business workflow processes of healthcare providers. For example, FIG. 4A depicts a typical workflow process at a clinic, where some of the business workflows are automated, but others are not. Cloud 410 shows that existing third party Electronic Medical Record systems leave automation “gaps”, such as (but not limited to): only over the telephone, manual verification of insurance eligibility; no automated verification of the identity of the patient; no base line of health data available to assist in the diagnosis and protocols for treatment; no predetermination of insurance payments; reduce claim rejection and diagnosing error risks by matching procedure with diagnostic codes, and the like. The invention provides for the integration of such types of additional functionality, which enhance the efficiency of existing systems and streamline the business workflows of the medical practices/clinics.

Thus FIG. 4B shows additional functionality, described below, provided by the invention and denoted as processes 470, 480 and 490, which are added to the clinic and shows how business workflows are improved through the new automation that the invention accommodates. For example, such automation may include software components to translate and bind third party vendors' software to one another so that the once unrelated third party software may share data for performing a transaction. Such integration becomes possible through the invention (even of dissimilar systems—also possible that some older systems may not have to be replaced as they may possible to integrate them with the EON Exchange system.) For example, the automation that identifies insurance eligibility results in the elimination of telephone calls to perform this task; the removal of this manual step normally results in a 10-15 minute gain in the time it takes to process and register a patient.

Another work flow advantage that re-engineers the processes of a medical practice is the ability the invention provides to predetermine the value of the payment from the insurance payer, and thereby also predetermine the amount of the portion of the payment that is the responsibility of the patient, while the patient is in the medical office, thereby eliminating all future payment steps such as billing and mailing, as well as promptly determining the primary versus secondary insurance coverage, thereby settling all insurance payments at patient discharge time. This is accomplished by accessing the EON Exchange databases to ascertain the insurance plan and payment requirements for the patient.

It should be noted that from a patient, an employer and an insurance Stakeholder point of view, such additional data may be in effect altering the way providers operate, in that the norm at present is for patients to seek medical care to fix a symptom or an illness that has taken place. However, with a baseline of health records (health screening) preventive care can take place based on test results, before the onset of illness.

Similarly, outcome data (metrics of success to treatment or drug therapy, or a pharmaceutical patient outcome) are also maintained, and such outcomes can affect the overall health of the general public, because of curative measures (preventative, habitual, or otherwise) that can be suggested when data are compiled as impersonal statistics for various medical conditions, by gender, by population centers (geography) by racial profile, by educational or economic stratification, etc.

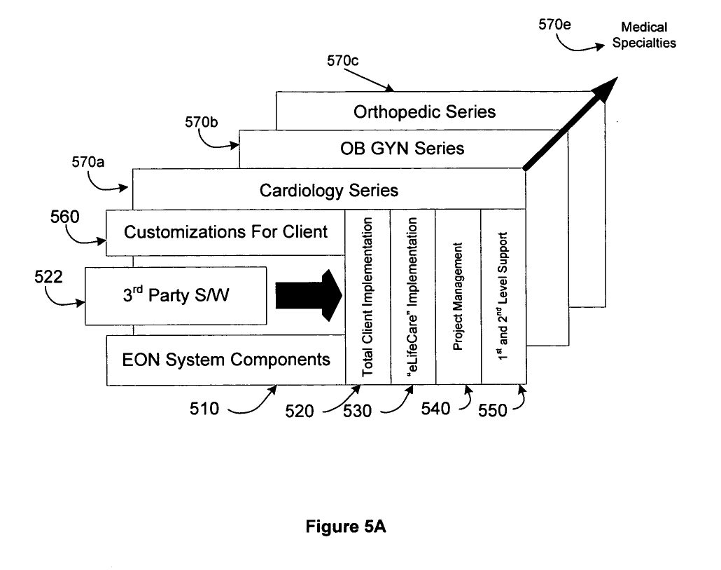

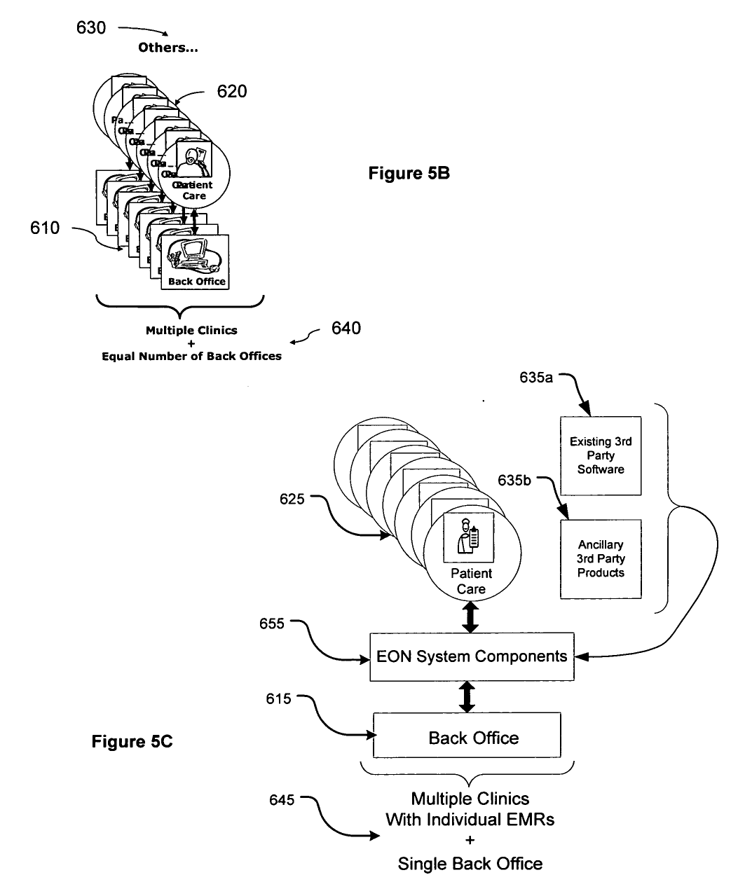

Another way to describe aspects of the invention is shown in FIG. 5A. In this example, the invention is used at a clinic that has or is acquiring an Electronic Medical Record (EMR) system from a third party. One or more software component(s) 510 of the invention “inserts into” or “surrounds” that third party EMR 522, and in addition, may accommodate any special client requests for customization (depicted by reference numeral 560, and which become integrated with EON Exchange) and assists the clinic with any changes that is needed to be implement, as depicted by reference numeral 520, such as upgrades to their clearing house for claims processing; input of the physicians AMA ID number; defining and assisting the clinic to implement new work flow procedures, or the like. Furthermore, these third party products are supplemented by implementation services (530) that are needed to effect the changes, and may include new definitions for the telecommunications network; other services, such as Project Management (540); long term support services (550), or the like.

Once the software component(s) and implementation services are implemented at a specific medical specialty, then other customized solutions (570) can be constructed as part of the implementation services, as necessary, for additional medical specialties.

The invention provides the additional operating capability of consolidating into one “back office” even dissimilar technology and systems (different programs, different software architectures, different operating systems, etc.) even when the EMR portion of the software products remain separate and dispersed, even when there is a different one per medical office. “Back office” refers to a logically single (physically it may be many) administrative and management function for tasks such as booking of appointments, preparation of coding of claims, submitting such claims to insurance and other private payers, accounting and bookkeeping functions and the like.

FIG. 5B shows the existing scenario prior to the invention offered by others, where they need to maintain or install either completely separate stand alone systems—one for each physical location (that offer the detailed features some of the medical specialties require) or subscribe to an ASP (ASP refers to Application Service Provider, a solution whereby the same software resides in some central location on one logical computing processor and database, thereby forcing all users to share the same level of detailed functionality without the capability to offer economically a solution that differs from medical specialty to medical specialty) model that offers an identical set of software features to all, regardless of whether they need more or specific functionality to accommodate the needs of their specialty. This problem may become significant when the client owns multiple medical specialties in many different geographic locations, and thereby is forced to have redundant staff in each location.

The system and process of the invention does away with this problem due to its ability to consolidate and normalize disparate information, as well as integrate. FIG. 5C shows the effect of consolidation and integration through the invention, whereby many different EMRs, including those from different vendors with disparate internal information formats, are able to be consolidated into a single back office, while keeping different software (different operating systems, different programs, etc. designated generally by reference numeral 625). The advantages of such integration include but are not limited to the ability to: operate as a single business entity; have a unified database for records (lessens errors and reduces costs); deploy a system that requires information is key entered only once (lessens errors, reduces costs); avail of the ability to run a single much simpler to operate and maintain, less expensive web site, etc.

Consolidation of multiple front office (patient care) EMR systems into one back office system offers improved control and accuracy when aggregating clinical data and higher operating efficiency through the ability to perform all administrative and financial functions in one location, thereby attaining economies of scale.

A further advantage provided by the invention is the ability to integrate with other third party devices (either existing devices, designated by reference numeral 635a, or as new additional devices, designated as reference numeral 635b) that then interface with the back office through the EON Exchange 655 other third party products are also shown in FIG. 5C. Some examples of such devices include: RFid (radio frequency control ID devices); remote voice transcription; heart monitoring; pulmonary testing devices, etc.; and other testing devices, such as tether-less personal monitoring devices (Blue Tooth telephones, PDAs, etc.) all conveying data into the EON Exchange thereby producing more automated and streamlined workflows, as well as accommodating rapid service through remote access to the EON system from which to obtain the patient's medical record remotely, in cases of emergency care.

The invention also manages processes securely so that users can enjoy an additional number of advantages, such as: seamless enterprise-wide functionality across multiple sites or in a campus environment, thereby obtaining reliable performance; ease of operation; optimizing patient care; optimizing business performance, and the like.

The invention creates “Clean Claims” for insurance reimbursements through our secure processes. A “Clean Claim” is produced when all necessary and required steps are prompted by the EON system and are either completed by the system automatically or alerts the user as to what is required. I.e., completeness and accuracy are checked prior to submission to an insurance company. For example, some insurance plans require the submission of an x-ray that has been signed by the attending physician; else it will not be reimbursed. In present day practice, most providers submit claims electronically, but signed x-rays are submitted by Postal Service. This separation of documents (even when both are submitted, and often they are not) creates a lengthy process of matching one submission with a separate transmission through another trail. At best, the claim gets processed, but it typically takes on average 90 to 120 days. A Clean Process assures that the necessary steps have been taken and the claim is “clean” for processing. If the claim generated is a “Clean Claim,” then the system arranges (for its clients that select this option, perhaps for a fee) to have an advance of up to 80% of the value of clean insurance claims paid to the medical provider typically within 24 to 48 hours. Then, the EON system automatically pursues the claim with the insurance payer and whenever they reimburse the practice, optionally, a fee may be deducted prior to providing the remainder to the provider.

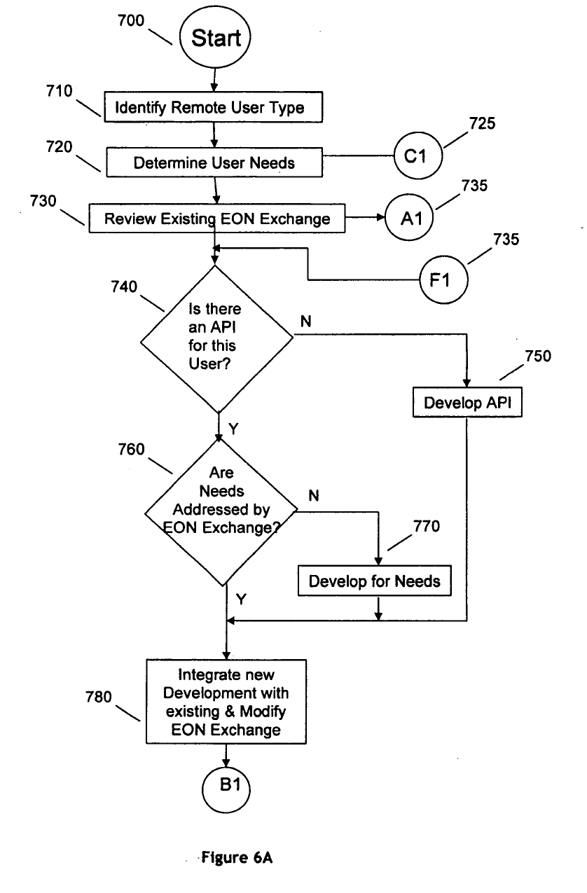

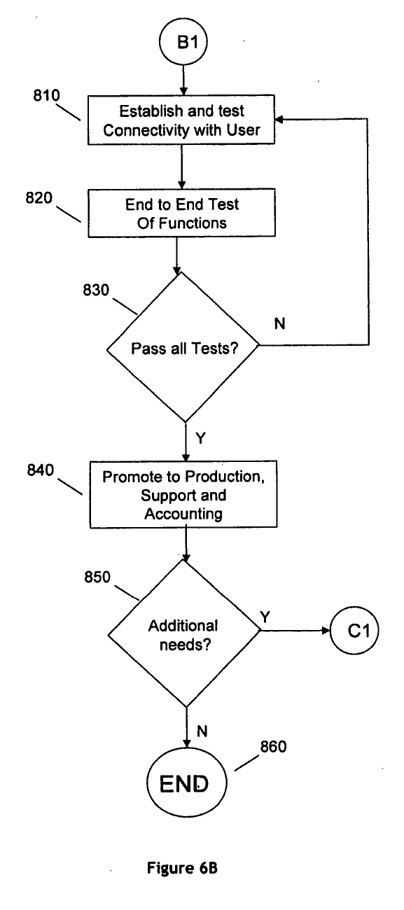

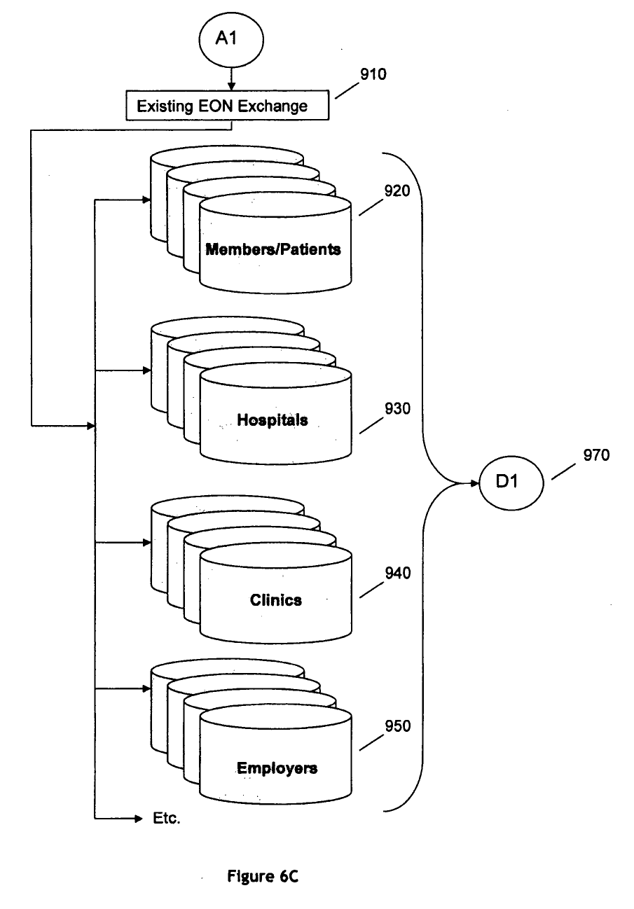

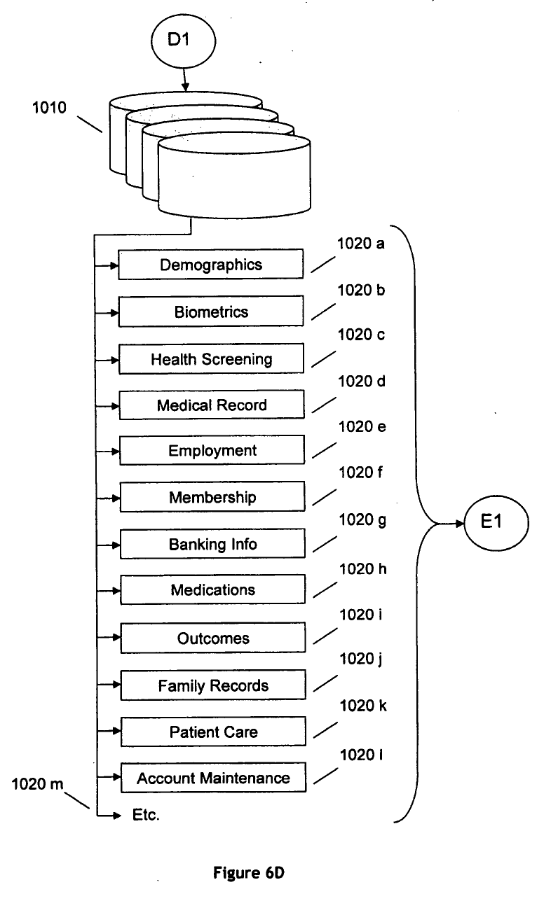

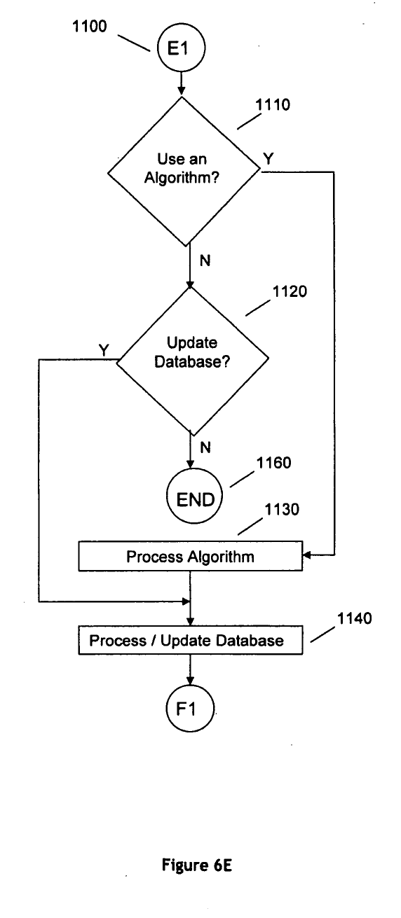

FIGS. 6A-6E are flow diagrams showing steps of an embodiment of the invention, starting at step 700. FIGS. 6A-6E, as well as any other flow diagram herein, may equally represent a high-level block diagram of components of the invention implementing the steps thereof. All or a subset of the steps of FIGS. 6A-6E, and all the other flow diagrams, herein, may be implemented in computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Further, the computer code may also be embodied, at least in part, in a medium such as a carrier wave, which can be extracted and processed by a computer. Additionally, the computer program code and any associated parametric data can be transferred to a workstation over the Internet or some other type of network, perhaps encrypted, using a browser and/or using a carrier wave. The steps of FIG. 6A-6E, as well as the other flow and relational flow diagrams herein, may also be implemented in the environment of FIG. 2, for example.

Continuing with step 710, when a user accesses the EON Exchange 210, typically via EON Toolbar 215, the type of user (e.g., employer, insurance company, hospital, clinic, or the like) and the identity of the user. At step 720, a determination is made as to what needs are being requested. For example, a request may be made to inquire about all the patients in a particular area who are on a particular medication. Or, perhaps, a request is being made to summarize the costs associated with a particular medical code. In general, a request may be made to acquire any data maintained in the system database which is typically maintained in a relational database, or similar type of database. Exemplary types of data that may be maintained and/or queried by the invention is listed in Appendix-I. Of course, any type of data associated with business operations (such as financial, employee and/or cost data) or data associated with records for patients or clients may be queried.

At step 730, a determination or review is made as to whether necessary data and/or supporting software is already existing as part of the EON Exchange. This is explained more fully in relation to FIGS. 6C-6E, below. At step 740, a determination is made if a particular application programming interface (API) is available for the particular type of user (e.g., a hospital interface, a pharmacy interface, or an insurance company interface). If the requested/required API is not available then at step 750, a new API is developed or acquired. Processing continues at step 780.

If however, at step 740, there is an API already available, then at step 760 a determination is made whether the requested user needs are adequately addressed by the EON Exchange. If not, then at step 770, new functionality is developed. If, however, the needs are addressed, then at step 780, any new development is integrated with the EON Exchange as part of its operational capabilities.

At step 810, connectivity with the user is established and tested to verify operational suitability of the new API related functionality. At step 820, an end to end test of functions related to the interoperability is performed. This verifies and validates correctness and completeness of communications and data integrity. At step 830, a determination is made whether all tests have succeeded. If not, corrections are performed related to the failure modes and the process continues at step 810. If, however, all tests pass the tests, then at step 840, the new functionality is promoted to production and accounting for general use. At step 850, a check is made whether there are additional user needs. If there are more needs, then the process continues at step 720. If there are no more needs, then the process terminates at step 860.

The process for determining user needs at step 720 is further detailed in relation to FIG. 6C, beginning at step 910. The existing EON Exchange database 212 may include database components (or portions of a database) associated with various exemplary stakeholders such as members/patients 920, hospitals, 930, clinics, 940, pharmacy, nursing services and/or employers 950, or any other similar stakeholder. These databases are checked for current functionality.

The current functionality check is illustratively shown as step 1010 (FIG. 6D), where the relevant database(s) may be checked for current functionality support (typically, but not exclusively, software) such as, for example, demographics 1020a, biometrics 1020b, health screening 1020c, medical records 1020d, employment 1020e, membership 1020f, banking info 1020g, medications 1020h, outcomes 1020i, family records 1020j, patient care 1020k, account maintenance 1020l, and/or other functionality 1020m. At step 1100, a check is made if an algorithm is required to fulfill the user needs. The algorithm may be any specific software module to calculate or transform data, such as for example, computing the average cost per visit for a patient. Or, perhaps, the algorithm may be for calculating the average number of people who have had a heart attack in a age range. If so, then at step 1440, the algorithm is processed and at step 1440, the appropriate database is updated with the results. The process continues with step 740. If no algorithm is necessary at step 1110, then at step 1120, a check is made whether a databases must be updates with new information, if not the process ends at step 1160. If an update is necessary, then the process continues at step 1140, described previously.

### Alternative Description

As an alternative, non-limiting description in view of the previous descriptions, EON Exchange may in aspects be a distributed system with intelligence (processing) and repository of records at many physical locations. The underlying assumption was that customers would have a relationship with a “Home” location (referred to as “Clinic”, though it may be a Clinic, but also a place of employment, a hospital, etc. and as such, the large majority of transactions would have been done at that (local) Clinic. The convenience of EON Exchange allows customers to make transactions at other (remote) Clinics. EON Exchange is designed to operate with the following attributes:
1. A Reliable Network System
2. Database Synchronization
3. A Central Head Office System (typically performing administrative and accounting services)
4. Multiple Clinic Systems
   A Reliable Network System:

The distributed design infers that the majority of transactions that take place at a Clinic are local transactions on the local network. However, whenever the need for an EON type transaction arises, it is necessary for the network to other Clinics to be available.

Database Synchronization:

EON Exchange may employ a daemon or two running on each server and a table (sync_db) that hold the transactions and instructions for database synchronization. Alternatively, peer-to-peer synchronization may be employed. Today, nearly all commercial databases come with database replication so there is no need to elaborate on the synchronization used with EON Exchange. Implementation of EON Exchange today takes advantage of the native data replication provided by the database.

A Central Head Office System:

Distributed Systems design has many advantages, but a hurdle is the need for centralized administration and reporting. The Head Office concept took care of this type of problems.
Business-wide rules are entered into the EON Exchange at the Head Office, and Database Synchronization is used to push those rules out to every Clinic sub-system. At the same time, any database activity taking place at the Clinics, are pushed to the Head Office making data readily available for centralized reporting. The Head Office is typically Clinic Number “H000”.
   Multiple Clinic Systems:

Database activity taking place at the Clinics, are pushed to the Head Office using database synchronization. Clinics receive business-wide rules from the Head Office by the same method. Clinics are typically given Clinic Numbers such as “0001” and “0107”.

At the lowest level, an EON transaction may be a remote SQL DML using industry standard syntax. For example:
SELECT <column_list,..>FROM<schema.><table>@<database_link>;

The SQL DML statements are generated by the application software, depending on which EON Clinic is the target of the SQL. The application components are implemented with databases on each Clinic server set up in the same manner. The data is set up in a schema called “ubanks” and the user is also called “ubanks”. Permissions allow remote users full access to the local database as long as the user name is the same. The application overwrites the actual logged-in user name with the generic “ubanks” to simplify administration. However, alternative implementation of EON uses the actual authorized user to eliminate any security risk.

Since the user of the data is always the owner of the schema, the application does not have to locate that information to generate the IHCS SQL DML. All it needs to get is the database_link for the Clinic it is trying to reach. That is found in the clnc_db table.

CLNC DB Table:

The clnc_db table is at the center of the EON Exchange design because it holds the Unique Clinic Numbers (primary keys) and the connection information for all Clinics in the system, including the Head Office. It also keeps the next sequence number for all the types of accounts that customers could open. The Head Office always has Clinic number “H000” and other Clinics were given Clinic numbers such as “0001” and “0107,” for example. This table is designed to contain two rows at the Clinic level. When each Clinic is set up, its new Clinic information is synchronized to the Head Office.

The Head Office has the connection information for every Clinic in the system in its clnc_db table. The invention is designed to make a remote read to the Head Office to get the connection information (database-link) for the Clinic with which your Clinic wants to communicate (in the CLNC_DATABASEID column). To get the Head Office database_link information in your local table, the following exemplary instructions may be used:
SELECT CLNC_DATABASEID
FROM CLNC_DB

WHERE CLNC_NO=‘H000’; —(returns b000_db)

To get the target Clinic database_link information from the Head Office, the following exemplary instructions may be used:
SELECT CLNC_LOCAL_SYSID, CLNC_DBASE_SYSID, CLNC_DB_SERVERID,
CLNC_DATABASEID FROM CLNC_DB@b0000_db
WHERE CLNC_NO=‘0107’; —(returns b0107_db)

When the target Clinic connection information is retrieved, a SQL DML query may be generated to perform direct remote data manipulation of the data in the target Clinic.
SELECT ACCT_STATUS
FROM SAV_DB@b0107_db
WHERE ACCT_KEY=12345670107;

Note that the SQL in the actual program code may be written as though it were being executed on the local machine. It is the External User Interface (XUI) that transforms the query at run time into a remote query.

Alternatively, the read to the Head Office may be eliminated to get the connection information for a Clinic. It involves having the clnc_db at every Clinic contain rows for every Clinic so that the target Clinic database_link information can be retrieved locally.
TABLE 2 shows a detailed exemplary layout of clnc_db.
   Home Clinic:

When a patient walks into a Clinic (perhaps Clinic 0001), and asks to be set up as a patient, the application uses a remote SQL search of the Head Office to be sure that the patient was not already set up anywhere in that Clinic. A record may be inserted in the cust_db table (see Table 3) for the new patient and the column CUST_HOME_CLNC and set to the code of that Clinic (0001), making that Clinic the patient's Home Clinic. The patient may proceed to receive healthcare services (Patient Account type #1) in one medical specialty at that same Clinic on that same day. The Home Clinic for that healthcare service would have been that Clinic (0001). The next day, the same patient could go to another Clinic, say Clinic 0107, to receive medical services in the same or a different medical specialty (Patient Account type #2). The registration process uses a remote SQL search of the Head Office to be sure that the patient is not already set up anywhere in that Clinic. It would find that the patient “belongs” to Clinic 0001. The EON process then copies a mini patient record down to Clinic 0107 in a table called xtac_db (see, Table 4). The Patient Account is then opened for the patient, but the Home Clinic of that Checking Account would still be Clinic 0107.

The xtac_db is used for retrieving patient identification information locally. But it is not sufficient for generating monthly statements because the patient address information still resides at the Head Office and Home Clinic. Generally, the concept of allowing the patient to create accounts at Clinics other than the Home Clinic caused numerous issues in the distributed architecture.

Account Number and Home Clinic:

When the patient opens a Patient Account at their home Clinic, the account number is generated for that account using the next available seven digit savings account number found in the CLNC_SAV_NO column of the local clnc_db table (which may have been 1234567, for example). To that seven digit number, the system appends the Clinic number of the home Clinic, so the account number for that patient account would have been 12345670001, for example. The CLNC_SAV_NO column is then incremented by one. So the general “rule” is that the home Clinic of an account can be easily determined by identifying the last four digits of the account number. But there is another column that is used if a remote read of the Head Office is forced.

The Home Clinic number is carried explicitly in the ACCT_HOME_CLNC column of the sav_db table. If the extraction of the Clinic number from the account number does not return a valid Clinic, a remote read of the sav_db table at the head office is done and it looks in this column. Patient Account are set up in the sav_db table and the account number is the primary key to that table(the ACCT_KEY column).

When the patient opens a different type of Patient Account at Clinic 0107, the same process transpires with the last four digits of that account number being 0107, and the ACCT_HOME_CLNC column also having 0107, for example. Table 5 shows the exemplary layout of sav_db.

Eon Processing:

Referring to the pseudo code in Table I below as an example, when a patient presents an EON Member Card to a receptionist, it typically includes the Account Type and Account Number to which that transaction pertains. The system accepts the account type and account number entered by the registering person. The account type tells the system which table to pull information from; account type SV meant looking into sav_db and DD meant looking into dda_db. The account type mapping is typically kept in memory.

The EON system takes the last four digits of the account number and compares in with its own clinic number which is also kept in memory. If a match is found, a local transaction is started. The comparison may be done by XUI. If the Clinic number extracted from the account number does not match the local Clinic number held in memory, the system then looks into clnc_db to find a match for the extracted Clinic number. The match tells the system which remote database to connect with to perform an EON transaction. A “remote session” is opened in the program code which signaled XUI to generate remote SQL whenever it encountered regular SQL in the program. A “close remote session” command in the program disables the remote SQL facility.

EON Exchange may be implemented with XUI, but that is not necessary, as there are other known implementation languages for a modem implementation.

TABLE 1
Pseudocode: Patient Diagnostics or Patient History transaction

```
Prompt/Accept Account Type
Prompt/Accept Account Number
XUI Uses Account Type to determine which Account table (Diagnostic,
Family History, Social History,...) and set up in $CALL-DBID(sav_db)
Extract last 4 digits of account number
XUI checks if it's a local account
If local account Then
  Proceed to DO_TXN_BLOCK
Else
  Read clnc_db for Clinic number
  If Clinic_number does not exist in clnc_db Then
    Open remote session to Head Office
    Select acct_home_clnc
      From $CALL-DBID(sav_db)
      Where acct_key = Accepted Account Number
    Close remote session to Head Office
    Open remote session to Home Clinic of Account
  Else (Clinic_number found in clnc_db)
    Open remote session to Home Clinic of Account
  End If
End If
DO_TXN_BLOCK:
      The SQL statements in the program looks like local SQL
      It is the remote session flag that causes XUI to capture
      the SQL and generate remote queries using the database_link.
      Sav_db is updated. Sav_tx is inserted. Jnal_tx is inserted
      In the remote database with flags to indicate the entry Clinic.
      if a remote session is detected, it is closed.
      cash_db and others are updated.
      Jnal_tx at the entry Clinic is inserted
End of transaction
```

```
TABLE 2
create table CLNC_DB  /* HOS.SYNC: H000 */
    (
      CLNC_NO  char  (4) PRIMARY KEY,
      CLNC_REGN  char  (2),
      CLNC_NAME  varchar (40),
      CLNC_ADDR1  varchar (28),
      CLNC_ADDR2  varchar (28),
      CLNC_ADDR3  varchar (20),
      CLNC_POSTCD  varchar (9),
      CLNC_TEL1  varchar (16),
      CLNC_TEL2  varchar (16),
      CLNC_LOGO  char  (5),
      CLNC_SYS_PRTID  char  (1),
      CLNC_LSR_PRTID  char  (1),
      CLNC_PBSIZE  decimal (2),
      CLNC_PB_ADDR1  varchar (14),
      CLNC_PB_ADDR2  varchar (14),
      CLNC_PB_ADDR3  varchar (14),
      CLNC_PB_ADDR4  varchar (14),
      CLNC_PB_ADDR5  varchar (14),
      CLNC_PB_ADDR6  varchar (14),
      CLNC_PB_ADDR7  varchar (14),
      CLNC_PB_ADDR8  varchar (14),
  /* account Number Control Fields */
      CLNC_CUST_NO  int,
      CLNC_SAV_NO  int,
      CLNC_DDA_NO  int,
      CLNC_SHA_NO  int,
      CLNC_TMD_NO  int,
      CLNC_TMS_NO  int,
      CLNC_GIC_NO  int,
      CLNC_RSP_NO  int,
      CLNC_CNS_NO  int,
      CLNC_INS_NO  int,
      CLNC_LCR_NO  int,
      CLNC_BLN_NO  int,
      CLNC_CLN_NO  int,
      CLNC_MLN_NO  int,
      CLNC_LAP_NO  int,
      CLNC_PLAN_NO  int,
      CLNC_SETLMNT_CODE  char  (2), /*TBL:TF:SETLMNT-
      CODES*/
  /* Clinic Special Accounts */
    /* Referral Medical History Account */
      CLNC_CCQP_ACCT  decimal (11,0),
    /* Lab Report Account */
      CLNC_LAB_APPL  char  (2), /* TBL: **:TWO-CODE-
      PRD */
      CLNC_LAB_ACCT  decimal (11,0),
    /* Treatment Protocol Account */
      CLNC_TRPR_APPL  char (2),  /* TBL: **:TWO-CODE-
      PRD */
      CLNC_TPPR_ACCT  decimal (11,0),
    /* Misc. Med Condition Account */
      CLNC_MISC_APPL  char  (2),  /* TBL: **:TWO-CODE-
      PRD */
      CLNC_MISC_ACCT  decimal (11,0),
      CLNC_CUSTNO  decimal (11,0),
      CLNC_PSWD_DATE  date,
      CLNC_PASSWD  char (8),
      CLNC_OUR_BIN  char (6),
      CLNC_EMB_PORT  char (14),
      CLNC_HSM_PORT  char (14),
      CLNC_PIN_PORT  char (14),
      CLNC_GRP_DATE  date,
      CLNC_GRP_NO  smallint,
      CLNC_GL_BASE_CURR  char (1), /* TBL: **:Curr Value */
      CLNC_GL_LOCL_CURR  char (1), /* TBL: **:Curr Value */
      CLNC_GL_HEAD_CURR  char (1), /* TBL: **:Curr Value */
      CLNC_LOCAL_SYSID  char (8),
      CLNC_DBASE_SYSID  char (8),
      CLNC_DB_SERVERID  char (8),
      CLNC_DATABASEID  char (8),
    /* Clinic Open/Close Indicator */
      CLNC_OPEN_CLOSE char (1), /* TBL: **:OPEN-CLOSE*/
          /* O: Open  */
          /* C: Foo-Close  */
          /* T: Temp.close  */
      CLNC_OPEN_DATE_TO date,
      CLNC_OPEN_DATE_YE date,
  /* GL Direct Trans Generation */
      CLNC_GL_POST_SW char (1), /* Y: Yes  */
          /* N: No  */
      CLNC_GL_POST_AMT int,
  /* EoD Operation Status Indicator */
      CLNC_GL_CONV_RUN_D date,
      CLNC_J_CUTOFF_DATE date,
      CLNC_GL_PERIOD_DTE char (254),
      CLNC_GL_PERIOD_SWH char (26),
      CLNC_ME_RUN_DATE  date,
      CLNC_JOB_SWITCHES  varchar (24),
      CLNC_2_STAGE_FLAG  char(1)
    );
```

```
TABLE 3
create table CUST_DB  /* HOS.SYNC: H000 */
  (
    CUST_KEY  decimal (11,0) PRIMARY KEY,
    CUST_STATUS  char (1),
                            /* TBL: **:CUST-STATUS */
        /* ACTIVE ... “A” */
        /* FROZEN ... “F” */
        /* CLOSED ... “C” */
        /* DELETM ... “X” */
        /* ::::::::::::  */
    CUST_CLASS  char (1),
                            /* TBL: **:CIF-CLASS */
        /* Personal  */
        /* Commercial  */
    CUST_TYPE  char  (1),
    CUST_HOME_CLNC  char  (4),
    CUST_SERVICE_REP  char  (8),
/* Name Fields */
    CUST_SH_NAME  char  (16),
    CUST_FULL_NAME  varchar  (80),
      /* -- 1st Name/Mail-Name-1 ---- */
      /* NAME_TITL char (4)  */
      /* NAME_SUR_NAME char (40)  */
      /* NAME_GVN_NAME char (18)  */
      /* NAME_MID_NAME char (18)  */
      /* --------------------------- */
      /* mask to: */
      /* /IBK/DEF/LIB/REC/01.name-rec */
    CUST_MAIL_NAME_1  varchar (80),
    CUST_MAIL_ATTN_1  varchar (40),
    CUST_MAIL_NAME_2  varchar (80),
    CUST_MAIL_ATTN_2  varchar (40),
    CUST_MAIL_NM_STMT  char  (1), /* mail name-Id */
    CUST_MAIL_NM_OTHR  char  (1), /* space/1/2 */
/* Address Pointers */
    CUST_MAIL_MKTG_SW  char  (1), /* TBL: **:YES-NO */
    CUST_STMT_CYCLE  char  (1), /* TBL:**:CYCLES1 */
            /* ------------- */
          /* ‘’ -No Stmt  */
          /* ‘M’ - Monthly  */
          /* ‘W’ - Weekly  */
          /* ...  */
    CUST_HOME_OWNERSHP  char  (1),
    CUST_STMT_G_DATE  date,  /* Stmt.generated date */
/* phone numbers and extensions */
    CUST_HOME_TEL_NO  char  (16),
    CUST_FAX_TEL_NO  char  (16),
    CUST_BUSI_TEL_NO  char  (16),
    CUST_BUSI_TEL_EXT  char  (4),
    CUST_DOB_REG_DATE  date,
    CUST_OPN_DATE  date,
    CUST_CLS_DATE  date,
    CUST_SEX  char  (1),
                            /* TBL: **:MALE-FEMALE */
    CUST_MARITAL_STAT  char  (1),
                            /* TBL: **:MARITAL-CDS */
    CUST_LANGUAGE  char  (2),
                            /* TBL: **:LANG-CODES */
    CUST_RESIDENCE  char  (3),
                            /* TBL: **:COUNTRY-CD */
    CUST_COUNTRY_CD  char  (3),
                            /* TBL: **:COUNTRY-CD */
    CUST_SIN_TIN  char  (16),
    CUST_EMP_STATUS  char  (1),
                            /* TBL: **:EMPL-STATUS */
    CUST_EMPLOYER  varchar (46),
    CUST_OCCUP_CODE  char  (2),
                            /* TBL: **:CUST-OCCUPTN */
    CUST_CRED_CNTRL  char  (1),
    CUST_OBSCURE_DATA  varchar (46),
/* Customer Identification */
    CUST_ID_TYPE_1  char  (16),
    CUST_ID_DESC_1  char  (20),
    CUST_ID_TYPE_2  char  (16),
    CUST_ID_DESC_2  char  (20),
    CUST_ID_TYPE_3  char  (16),
    CUST_ID_DESC_3  char  (20),
    CUST_REMARKS_1  varchar (46),
    CUST_REMARKS_2  varchar (46),
    CUST_SIGNAT_IND  char  (1),
    CUST_PHI_ACNT  smallint,
    CUST_DIA_ACNT  smallint,
    CUST_INS_ACNT  smallint,
    CUST_TMD_ACNT  smallint,
    CUST_TMS_ACNT  smallint,
    CUST_RSP_ACNT  smallint,
    CUST_GIC_ACNT  smallint,
    CUST_CLN_ACNT  smallint,
    CUST_LCR_ACNT  smallint,
    CUST_MLN_ACNT  smallint,
    CUST_BLN_ACNT  smallint,
    CUST_SHA_ACNT  smallint,
    CUST_CSV_ACNT  smallint
  );
```

```
TABLE 4
/*  Mini-Customer Information Table  */
/* Please note that the primary key for this table when created */
/* at the Head Office should be “CUST_KEY & CUST_CLNC” */
create table XTAC_DB  /* HOS.SYNC: H000 */
  (
    CUST_KEY  decimal (11,0),
    CUST_SH_NAME  char (16),
    CUST_FULL_NAME  varchar (80),
    CUST_STATUS  char (1),
                            /* TBL: **:CUST-STATUS */
        /* ACTIVE ... “A” */
        /* FROZEN ... “F” */
        /* CLOSED ... “G” */
        /* DELETM ... “X” */
        /* ::::::::::::  */
  CUST_HOME_CLNC  char (4),
  CUST_CLNC  char (4),
  CUST_CLASS  char (1),
                            /* TBL: **:CUST-CLASSES */
        /* Personal  */
        /* Commercial  */
    CUST_TYPE  char (1),
    CUST_DOB_REG_DATE  date
  );
create unique index XTAC_DB_IX1 on XTAC_DB (CUST_KEY,
CUST_CLNC);
```

TABLE 5

```
create table PHI_DB /*  HOS.SYNC: H000 */
  (
  /* dda-db.tbl is same as this table definition */
  /* 960902 New Index Added for Online & Batch Pf*/
    ACCT_HOME_CLNC  char (4) NOT null,
    ACCT_OFFICER  char (8) NOT null,
    ACCT_KEY  decimal (11,0) PRIMARY KEY,
    ACCT_ALTKEY  decimal (11,0) NOT null,
    ACCT_STATUS  char (1) NOT null,
            /* TBL: **:ACCT-STATUS */
    ACCT_OPN_DATE  date NOT null,
    ACCT_CLS_DATE  date,
    ACCT_STA_CHG_DATE  date,
    ACCT_STATUS  decimal (18,2),
    ACCT_FTX_DATE  date,
    ACCT_LTX_DATE  date,
    ACCT_LTX_TIME  int,
    ACCT_LPR_DATE  date,
    ACCT_LPR_TIME  int,
    ACCT_PREF_INT  char (1),
    ACCT_PREF_SC  char (1),
    ACCT_EVENT_LOOK  char (1),
    ACCT_REF_DATA  varchar (24),
    ACCT_APPL  char (2) NOT null,
                /* TBL: **:TWO-CODE-PRD */
    ACCT_ATYP  char (2) NOT null,
    ACCT_CU_ID  char (1) NOT null,
                /* TBL: **:Currencies */
    ACCT_IR_TYPE  char (1) NOT null,
                /* TBL: **:INT-RATE-TYP */
    ACCT_FX_RATE  decimal (9,4),
    ACCT_ADJ_VAL  decimal (9,4),
    ACCT_GUR_LOW  decimal (9,4),
    ACCT_GUR_HGH  decimal (9,4),
    ACCT_INTC_DAY  smallint NOT null,
    ACCT_IB_TYPE  char (1) NOT null,
                /* TBL: **:BNK-IB-TYPE */
    ACCT_IP_TTYPE  char (1) NOT null,
                /* TBL: **:CYCLES1 */
    ACCT_SP_TTYPE  char (1), /* TBL:**:CYCLES1 */
    ACCT_IN_POST_MON  decimal (2,0),
    ACCT_SC_POST_MON  decimal (2,0),
    ACCT_SC_PLAN  char (2),
    ACCT_OD_OPTN  char (1), /* TBL: **:OD-OPTIONS*/
    ACCT_RP_OPTN  char (1) NOT null,
                /* TBL: **:CUST-RPT-OPT */
    ACCT_ODRATE_ADJ  decimal (9,4),
    ACCT_ODR_REVIEW_D  date,
    ACCT_LIC_DATE  date NOT null,
    ACCT_LIP_DATE  date NOT null,
    ACCT_SVC_DATE  date NOT null,
    ACCT_TOT_INT  decimal (18,2),
    ACCT_UNP_INT  decimal (18,2),
    ACCT_TOT_SC  decimal (18,2),
    ACCT_UNP_SC  decimal (18,2),
    ACCT_ODI_TOT  decimal (18,2),
    ACCT_ODI_UNP  decimal (18,2),
    ACCT_LC_LIMIT  decimal(18,2),
    ACCT_LC_EVAL_DATE  date,
    ACCT_MIN_BAL  decimal (18,2),
    ACCT_AVG_BAL  decimal (18,2),
    ACCT_WHTAX_SWCH  char (1), /* TBL: **:YES-NO */
    ACCT_SV_SIGNNO  decimal (2),
    ACCT_DORM_DATE  date,
    ACCT_MINB_DATE  date,
    ACCT_MINB_SAVE  decimal (18,2),
    ACCT_ME_UINT  decimal (18,2),
    ACCT_ME_UODI  decimal (18,2),
    ACCT_OD_LIMIT  decimal(18,2),
    ACCT_USG_CODE  char (3),
    ACCT_RESERVED  char (32)
    );
create index PHI_DB_IX1 on PHI_DB (ACCT_ALTKEY);
create index PHI_TBALX1 on PHI_DB
  (ACCT_HOME_CLNC, ACCT_ATYP, ACCT_CU_ID,
  ACCT_KEY);
```

The following APPENDIX-I is an exemplary description of the various database elements that may be maintained as part of the EON Exchange. These elements are searchable and updateable by the Stakeholders, typically through the EON Toolbar, subject to security authorization controls to protect information from unauthorized access. Appendix-I is organized into three columns, “Application,” “Functions,” and “EON SYSTEM features.” The “Application” column refers to the software application that provides the functions as shown in the “Functions” column. The “Functions” column describes the basic function being provided, while the “EON SYSTEM features” column more fully describes the characteristics or capabilities of the “Functions” for the “Application,” in more detail.

| APPLICATION | Functions | |
|---|---|---|
| | | EON SYSTEM Features |
| MPI | Master Participant | Records and tracks all EON care |
| | Index | participants, with commonly |
| | | required demographics: |
| | | Universal Patient ID capable, 20 |
| | | character alphanumeric Unique ID |
| | | generated for each Participant on |
| | | entry. |
| | Master Participant | Allows user to Search by 25 |
| | Index Locator | different organizational Keys |
| | | “Types” all EON care Participants, |
| | | with single or multiple indicators, |
| | | tying the different relationships |
| | | and roles together with one |
| | | Unique Identifier. |
| | | Allows user access to enter and |
| | | manage “type” specific profiles, |
| | | additional data that applies only |
| | | to that type of Participant. |
| | | Groups all entities by |
| | | Organization, Group, Division, |
| | | Location, Department |
| | Add/Update New | Common file for all Participants |
| | Participants | can be shared across multiple |
| | | accounts and EON installations. |
| | | No redundant MPI data. |
| | | 50% of EON System Set-up is |
| | | facilitated thru the MPI. |
| | | Archives and Date/Time Stamps |
| | | each subsequent change of any |
| | | info in the Participant's Profile |
| | | MPI Common demographics |
| | | include: Name |
| | | First Name |
| | | Middle Name |
| | | Last Name |
| | | Prefix |
| | | Appellation |
| | | Alternate ID |
| | | Individual ID |
| | | Organization ID |
| | | Group ID |
| | | Division ID |
| | | Location ID |
| | | Address One |
| | | Address Two |
| | | City |
| | | State |
| | | ZIP |
| | | COUNTY |
| | | COUNTRY |
| | | TIME ZONE |
| | | E-MAIL Address |
| | | Effective Date |
| | | Termination Date |
| | | Phone #1 |
| | | Phone #2 |
| | | Phone #3 |
| | Patient Profile | Patients- full demographic profile |
| | | as described in Registration |
| | Responsible Party | Responsible Parties - all |
| | Profile | necessary guarantor data for |
| | | billing and accounting. |
| | Member Profile | a. Member Enrollment Data |
| | Dependent Profile | b. Dependent Data |
| | Provider Profile | Providers- see Provider |
| | | Credentialing in Managed Care for |
| | | description detail |
| | Security Profile | Security (Users)- Profile data |
| | | Multiple accounts management for |
| | | access |
| | Organization Profile | Organizations' details including |
| | | Contact Names and Phones |
| | Division Profile | Divisions |
| | Location Profile | Locations |
| | Department Profile | Department details, including |
| | | Contact Info |
| | Payer Profile | Payer Profile Details |
| | | Payer Contract entry and tracking |
| | | by Effective and Term Dates |
| | | Pre-certification, authorization, |
| | | and eligibility verification phone |
| | | number fields. |
| | | Billing defaults including |
| | | electronic submission indicator |
| | | and the corresponding submitter |
| | | name and file format. |
| | | Payer classifiers Source of |
| | | Payment and Payer Class. |
| | | Administrative Payer assignment. |
| | Payer Plan | Includes plan, network, coverage |
| | Assignment | ID's along with effective and |
| | | termination dates. |
| | | Ability to assign unlimited plans |
| | Payer Contract | Includes contract, network, |
| | Assignment | coverage ids along with effective |
| | | and termination dates. |
| | | Ability to assign unlimited plans. |
| | | Ability to restrict how often a |
| | | payer is billed for services using a |
| | | given contract based on the Billing |
| | | Parameter. |
| | Group Practice Profile | Group Practices- Lists all |
| | | associated Providers |
| | Electronic Submitter | Electronic Submitters- set-up and |
| | Profile | defaults for any e-submissions, |
| | | claims and connectivity |
| | | transactions to Clearing Houses |
| | | and Claims Processors |
| | | Ability to profile any participant |
| | | who submits EDI files for EON |
| | | functions: HCFA Claims, UB92 |
| | | Claims, Medi-Cal, 1099 (IRS). |
| | | Contact Names and Phones |
| | | File Parameters for multiple file |
| | | formats submitted. User may |
| | | submit any or all. |
| | | Settings for sequence numbers, |
| | | pass words. |
| | | Settings for any number of file |
| | | formats. |
| | Employer Profile | Employers Contact Names and |
| | | Phones |
| | Group Profile | Groups Contact Names and |
| | | Phones |
| | Network Profile | Networks Contact Names and |
| | | Phones |
| | Facility Profile | Facility details include Type of |
| | | Facility (standard codes) and |
| | | Fiscal Year settings for |
| | | accounting. |
| | Vendor Profile | Vendor Contact Names and |
| | | Phones |
| | | Billing Address |
| | | Shipping Address |
| | Personnel Profile | Personnel details include DOB, |
| | | Marital Status, Gender |
| | | State Drivers License, State |
| | | Indicator |
| | | Race, Citizenship, SSN |
| | | EEO # |
| | | Type of Resource, Personnel |
| | | Status |
| | Pharmacy Profile | Pharmacy's details include the |
| | | NABP # |
| | | Network Participation |
| | | maintenance and tracking. |
| | Fund Profile | Funds - set up funds |
| | | administrator such as banks and |
| | | TPAs |
| | | Set-up multiple accounts within a |
| | | Fund Manager |
| | | Contact Info including Name, |
| | | Email address, and Phone number |
| | | Ability to load multiple bank |
| | | account numbers to one fund |
| | | Assign check group id to each |
| | | account for use with check |
| | | printing software partner ACOM. |
| | | Ability to restrict check numbers |
| | | assigned from each account. |
| | | Cycle code assignment allows |
| | | grouping of accounts for check |
| | | batch processing based on date |
| | | intervals. |
| | | Next Print Date shows when |
| | | checks for an account will be |
| | | printed again. |
| | | Check Process Code indicates |
| | | whether checks for this account |
| | | will be processed to pay either |
| | | one or multiple events. |
| | Customer Profile | Contact Names and Phones |
| | | Billing Address |
| | | Shipping Address |
| Scheduling | Patient | Manages schedules and appointments |
| | Appointment | across multiple locations for any |
| | History | Practice Enterprise |
| | | Patient Central View of appointments |
| | | and Patient Appointment history |
| | | across Facilities and Providers. |
| | | Patient Frame displays all pertinent |
| | | info for a Patient you are scheduling. |
| | | You can use the Finder to bring up |
| | | the Patient's Appointment History. |
| | | You can add a person directly thru |
| | | the MPI, and schedule them, or |
| | | access anyone for scheduling directly |
| | | from the MPI |
| | Add/Update | Search for Open Appointments by and |
| | Appointment | across Facilities. |
| | | Search for Open Appointments by and |
| | | across Providers. |
| | | Search for Open Appointments by |
| | | Calendar Date or User Specified Date |
| | | Range |
| | | Search for Open Appointments for |
| | | specific services and variable user |
| | | defined time slots. |
| | | Search for special slots for specific |
| | | Department openings. |
| | | Search for special slots for specific |
| | | Floor openings. |
| | | Search for special slots for specific |
| | | Unit openings. |
| | | Search for special slots for specific |
| | | Room openings, like Exam Rooms. |
| | | View Openings for selected searches |
| | | and choose desired appointment. |
| | | View openings with all other overlaps |
| | | and booked areas. Overlaps and |
| | | booked areas are color coded for |
| | | management, and easy viewing. |
| | | Overbooking capabilities with |
| | | warning messages. |
| | | Patient Central view allows user to |
| | | see Account balance and status when |
| | | scheduling. |
| | | Appointment generates encounter |
| | | info for Pull lists and Encounter |
| | | forms. All appointments connected to |
| | | Physician Notes, Encounters and |
| | | charges. |
| | | Can make appointments with |
| | | Personnel, like billing staff or Pre- |
| | | cert Consultants. |
| | | Allows “Wave” Scheduling |
| | | “Pending”, “Confirmed”, and |
| | | “Completed” status settings. |
| | Automated | “Reschedule” status automatically |
| | Rescheduling | guides user thru moving the |
| | Functionality | appointment to new location and |
| | | time. |
| | | Data can carry thru for search for |
| | | rescheduling or, you can change any |
| | | part of it. |
| | | “No-show” and Cancellations are |
| | | stored for tracking Patient |
| | | Appointment History. |
| | | Put a Patient on the “Wait List” with |
| | | any preferences, including Physician, |
| | | times or Services. |
| | Wait List | Wait List Management, find any and |
| | Management | all-waiting details and automatically |
| | | put them in a new place when called |
| | | for. |
| | | When you've made and appointment, |
| | | during the day, for a walk-in, you can |
| | | generate the Encounter Form, by |
| | | Patient Name immediately. |
| | | Details for appointment, including |
| | | Patient Phone #'s, and Co-pay |
| | | displayed at all times. |
| | | Add a Text Comment to each |
| | | Appointment. |
| | | Add a “complaint” or reason for the |
| | | visit to each appointment. |
| | | Displays “Special Instructions” for |
| | | service, to patient in details. |
| | | Right click and Print the Patient |
| | | Appointment Update Screen for |
| | | Patient Info on next appointment. No |
| | | more handwriting little cards. |
| | | Tracks user-defined referral |
| | | indicators: Yellow Pages, friends, |
| | | doctors, etc. |
| | | Enter and track “Recall” Dates. |
| | Check Benefits | Can View Patient's Benefit Plan for |
| | when Scheduling | access to referral requirements, Co- |
| | for Referrals and | pay, etc. See Benefit Plan Summary. |
| | Authorization | |
| | needs. | |
| | Searches and | Access Schedules for Single or |
| | Views by Facility, | Multiple Physicians (unlimited) at any |
| | with Add/Update | Facility |
| | | Access Schedules for any Date Range |
| | | or block of time. |
| | | Manage any appointment on the |
| | | Facility Appointments schedule view |
| | | by clicking on it, to access Updating |
| | | capabilities. |
| | | Print any view created by right-click |
| | | and print feature. |
| | Searches and | View without Provider Name for |
| | Views by | multiple Physicians Views. |
| | Provider, with | |
| | Add/Update | |
| | | Create Views for specific types of |
| | | services: Example: all Physicals |
| | | scheduled for a week for a Provider. |
| | | Manage any appointment on the |
| | | Provider Appointments schedule view |
| | | by clicking on it, to access Updating |
| | | capabilities. |
| | | Search and locate any one existing |
| | | appointment and it's details for |
| | | Patient. |
| | Personnel | Search for and view the work |
| | Schedule View | schedules and break times set up for |
| | | any Provider or Personnel. |
| | | Search for and view the full |
| | | personnel schedule and break times |
| | | set up for any Facility. |
| | | Manage and make changes to any |
| | | schedule, day or break accessed on |
| | | the View List. |
| | | Set-up Vacation Times. |
| | | Set and Track Sick days. |
| | | Schedule for personnel such as |
| | | Receptionists and other non-care- |
| | | providers. |
| | | Scheduling Availability covers 7/24 |
| | Create New | Create Provider and Personnel |
| | Schedules | availability/schedules by using easy |
| | | templates. |
| | Monitor and | Cycle out Scheduling Templates for |
| | Change | any amount of days, weeks or years |
| | Schedules | ahead of time. |
| | Apply Templates | Apply Vacation Days within the |
| | for Long Term | template, that vary from the usual |
| | Schedules in | routine. |
| | seconds. | |
| | Scheduling Set- | Create custom Scheduling |
| | Up | parameters for any Provider or |
| | | Personnel, for any Location, even |
| | | each Floor, Unit and Room within a |
| | | Facility. |
| | Service Events | Define all of the particular Service |
| | | Events that happen in your Facility or |
| | | in multiple Facilities. |
| | | Name the event any user-friendly |
| | | term that works for your |
| | | environment. |
| | | Set any user-defined variable for the |
| | | length of the service (15, 20, 30, 60 |
| | | minutes). The Scheduler can |
| | | automatically identify proper time |
| | | slots for these events. |
| | | Determine what Department, Floor, |
| | | Units and Rooms, and even beds, |
| | | where a particular service can be |
| | | scheduled. |
| | | Define what procedure code is |
| | | connected to this event. |
| | | Define Special Instructions for |
| | | Patients concerning this service. |
| | | Define the Resources or team of |
| | | personnel that are needed to perform |
| | | or attend this event. |
| | | Define special or specific events |
| | | custom for each Provider when |
| | | necessary. |
| | | Define materials or equipment |
| | | needed for each event. |
| | Scheduling | Create Custom Templates for each |
| | Templates | Provider |
| | | Name the Template any thing that |
| | | works for you, and set it up for any |
| | | combination of days during the week. |
| | | Create multiple templates for a |
| | | physician who works different hours |
| | | in different facilities. |
| | | Create pre-defined break times, that |
| | | can be different each day. |
| | | Create Templates for all Personnel, |
| | | such as nurses and office staff. |
| | Rooms | Create the model for your facility, |
| | | start by adding user-defined codes |
| | | for allyour departments, floors, units |
| | | and rooms. Unlimited entry |
| | | supported. Small Clinic or large |
| | | hospital. |
| | | Add combinations of Department, |
| | | Floor, Unit, and Room for use in |
| | | finding specific schedule openings. |
| | | Search for any Facility listing of |
| | | Rooms, or find a particular one, to |
| | | manage and Update. |
| | | Define the times during the day when |
| | | the rooms will be available. You can |
| | | have rooms that are available 24/7 |
| | | or just from 9-5. |
| | | Define or check current status of |
| | | room. |
| Registration | Patient Card | Find It allows Searches for Patients |
| | Frame | by a wide variety of forms and |
| | | variables. Drill downs can find any |
| | | Patient in the system by Name, DOB, |
| | | Account #, SSN, Date of Service, |
| | | Member ID, Individual, Alias, |
| | | Address and Medical Record #. |
| | Patient Find It | Finder can use any combination of |
| | | the values in the Patient Profile. |
| | | All searches use search parameters |
| | | of partial words, and use “soundex” |
| | | for names and text items. |
| | | Finder can view user defined set of |
| | | records and numbers to control |
| | | scrolling and performance. User can |
| | | choose more or less depending on |
| | | preferred views. |
| | | Finding a Patient allows the Patient |
| | | Card to show all the most valuable |
| | | info that Physicians and staff want to |
| | | see all the time while viewing and |
| | | managing the Patient record |
| | | longitudinally. |
| | | Patient Card stays visible throughout |
| | | all Patient central point of Service |
| | | functions. |
| | | Central to all Patient Views, Patient |
| | | Name, Address, Individual ID, SSN, |
| | | Primary Care Provider, Co-pay for |
| | | Primary, Account Balance, Account |
| | | Status. |
| | Add New Patient | View of Patient Demographics: From |
| | | MPI and Patient Profile combined to |
| | | comprise 90% of all required data |
| | | capture, in one screen. |
| | | Common demographics, including: |
| | | date of birth, marital status, |
| | | employment status, sex, billing |
| | | defaults per Patient. |
| | Patient Admin | 99% of all Patients can be |
| | | effectively Registered in the first |
| | | screen, in under 30 seconds. |
| | | Over 120 unique fields of data |
| | | captured for the Registration |
| | | process. |
| | | Individual ID is available for up to 20 |
| | | characters, so if the Patient does not |
| | | have a Social # then the field can |
| | | accept other Ids and SSN as well. |
| | | Specific SSN field is pre-formatted |
| | | and does not allow duplicates. |
| | | Perform Primary Care Provider |
| | | Assignment |
| | | Record Patient's current or favorite |
| | | Pharmacy for call-ins and E- |
| | | prescriptions. |
| | | Name is captured as Name, but also, |
| | | as First Middle and Last, discreet |
| | | fields. |
| | Account Set-Up | Account Set-up is automatic with |
| | | unique ID account ID generation and |
| | | Effective Dates and billing |
| | | parameters automatically filed on |
| | | first entry of Patient. |
| | | Assigns the guarantor on creation of |
| | | Patient Profile, from user entry or |
| | | defaults to patient. |
| | Transfer an | Transfer an account and all it's |
| | Account | financial records and responsibilities |
| | | to another guarantor, in seconds. |
| | Terminate an | Terminate an Account, when no |
| | Account | balance is present. |
| | Manage Account | Change the Account Status, which |
| | Status | can turn the statement billing “off” |
| | | or “on”. |
| | Change Billing | Change the Statement Billing |
| | choices and | Parameters, which allows the user to |
| | Parameters | change the dates and frequency the |
| | | Patient or Guarantor is billed for |
| | | from Patient Statement. |
| | Employment | Enter the Patient's Employment |
| | | Record |
| | | Includes Employment Date, Employer |
| | | Name. |
| | | Also captures Nature of Business, |
| | | and specific duties or title of |
| | | Employee. |
| | Military Info | Enter the Patient's Military Service |
| | | Card information |
| | | Captures Service Branch, Service |
| | | Grade, Service Status, Program |
| | | Participation and Effective and Term |
| | | Dates. |
| | Insurance | Insurance History and Present |
| | Coverage | records displayed in order of Priority. |
| | | Can Update or access to Verify |
| | | Eligibility for any one of them from |
| | | main view. |
| | Add/Update | Enter the-Patient's coverage(s), |
| | Coverage | unlimited if necessary |
| | | Records by Effective and Termination |
| | | Date so the user can store previous |
| | | plan Info for any priority (primary, |
| | | secondary, tertiary) |
| | | Unlimited ability to add additional |
| | | coverages (Worker's Comp, FLEX |
| | | Plans, etc.) |
| | | Record for each Payer: specific Plan, |
| | | Product, Network, Coverage and |
| | | Coverage Type |
| | | Capture the Insured data, whether |
| | | Self or other Relationship, with |
| | | Member ID. |
| | | Group ID |
| | | Edits the user, to prevent incorrect |
| | | coverage entries: cannot change an |
| | | insurance that has open items left for |
| | | receivables Improperly. All required |
| | | fields for billing must be present. |
| | | Edits for valid Member Ids like Medi- |
| | | Cal. |
| | Plan summary | Search for and attach a Plan |
| | | Summary for each insurance plan |
| | | recorded, for access to requirements, |
| | | like referrals, co-pays and |
| | | deductibles. |
| | | Plan ID |
| | | Product ID |
| | | Product Name |
| | | Coverage ID |
| | | Coverage Name |
| | | Co-Pay Amounts |
| | | Annual Deductibles |
| | | Annual Coinsurance |
| | | Annual Out-of Pocket |
| | | Lifetime Maximum |
| | | Annual Deductibles Met Amounts |
| | | Annual Coinsurance Met Amounts |
| | | Annual Out-of Pocket Met Amounts |
| | | Lifetime Maximum Met Amounts |
| | Plan Summary | Identify and record benefit items |
| | Details | that require Referrals, |
| | | Authorizations, Not covered, etc. Or |
| | | have special limits on monies, |
| | | expenses, occurrences, etc. |
| | Extended | Race |
| | Registration | |
| | | Ethnicity |
| | | Number of Children |
| | | Number in Household |
| | | Salary |
| | | Driver's License # |
| | | Patient Status |
| | | Co-Pay |
| | | Patient Salary |
| | Chart Tracker | Enter and track Medical Record #s to |
| | History | coordinate with paper charts, |
| | | additional to the EMR. |
| | Chart Check In- | Check in and Check Out allows user |
| | Out | to assign Reasons for Medical Record |
| | | use, and User/Date/Time stamp for |
| | | historical record usage. |
| | Contacts | Enter as many contacts as you need |
| | | for any Patient, for emergency and |
| | | communication purposes. Example: |
| | | Parents, Guardians, Child Care |
| | | Contact Name |
| | | Relationship to Patient |
| | | Gender |
| | | Home Phone |
| | | Work Phone |
| | Patient Content | Special Picture ID's can be stored for |
| | | Patient and viewable on-line as |
| | | thumbnail in the Patient Admin |
| | | screen. |
| | Manage and | Upload any multimedia file and |
| | Exchange Content | attach to Patient Record and store in |
| | with other | database for viewing, listening, |
| | Providers | storing, and exchange of information |
| | | about the patient. |
| | | Files are Typed and categorized and |
| | | can be any kind of file that a |
| | | browser, with or without plug-ins |
| | | can activate. |
| | | Download content for exchange. |
| | | Examples are scanned documents, |
| | | pictures, sound files, read-only, such |
| | | as lab test results. |
| | Comments | View of all historical Notes, this field |
| | | can 64,000 bytes per note. |
| | | All Notes are Date/Time/User |
| | | stamped on entry and cannot be |
| | | deleted or changed by users. |
| | Message Bar | Up□ and Down□ Arrows let you |
| | Viewer | scroll through text messages and |
| | | notes for the Patient you have |
| | | accessed. |
| | Add New Message | From the Message bar you can add |
| | | new Notes or Comment while using |
| | | any other Patient Central function or |
| | | feature. |
| Authorizations | Add Physician/ | Create and Track Managed Care |
| | Provider Referral | Referrals In a Patient Central View |
| | Request | |
| | | Enter Referrals To and From the |
| | | Primary Care Provider, or Specialist |
| | | to Specialist |
| | | Referrals tagged with Payer (specific |
| | | to what Patient is eligible for) Date |
| | | and Reason |
| | Specify Services on | Specify any line item(s) for detailed |
| | Referral | referral process, such as Physical |
| | | Therapy treatments with multiple |
| | | procedure codes |
| | | Each line item has a From and Thru |
| | | Date for referrals that expire |
| | | Each requested procedure can have |
| | | Multiple Diagnosis codes |
| | | Each line item has a revenue code |
| | | that can be applied. |
| | | Each procedure can use up to four |
| | | modifiers |
| | | Each procedure can use Length, Unit |
| | | and Occurrence calculations |
| | | Each item can have a requested |
| | | amount and record an approved |
| | | amount. |
| | | Each item has the ability to be |
| | | approved or denied, so each line item |
| | | can be processed property within the |
| | | request |
| | Approve or Deny, | Approved Referrals require an |
| | full or partial | Approval/Auth ID, and can be used |
| | | then in other applications like |
| | | Encounters and Billing |
| | Add | Create Requests for Authorizations or |
| | Authorization/Pre- | Pre-Certifications for services |
| | certification Request | |
| | | Enter Requests for any Provider, to |
| | | any Payer on the Patients list of |
| | | coverage |
| | | Referrals Date and Reason |
| | | Each line item has a service code that |
| | | can be applied. |
| | Specify Services to | Specify any line item(s) for detailed |
| | be certified or | treatments with multiple procedure |
| | Authorized | codes such as surgery, |
| | | Each line item has a From and Thru |
| | | Date for exact application of the Pre- |
| | | Cert |
| | | Each requested procedure can have |
| | | Multiple Diagnosis codes |
| | | Each procedure can use up to four |
| | | modifiers |
| | | Each procedure can use Length, Unit |
| | | and Occurrence calculations |
| | | Each item can have a requested |
| | | amount and record an approved |
| | | amount. |
| | | Each item has the ability to be |
| | | approved or denied, so each line item |
| | | can be processed properly within the |
| | | request |
| | Approve or Deny, | Approved Pre-Certs and |
| | full or partial | Authorizations require an |
| | | Approval/Auth ID, and can be used |
| | | then in other applications like |
| | | Encounters and Billing |
| | | Contact Follow-up Name |
| | | Contact Phone |
| Medical Records | | Supports aggregate as well as |
| | | encounter specific views of clinical |
| | | data. |
| | Health History | Problem List view, updated from |
| | | previous encounters, diagnoses, with |
| | | date and status. |
| | Allergies History | Allergies aggregate view, unlimited |
| | and Search View | entry ability and accrue over all |
| | | entries for all encounters. |
| | Add/Update Allergy | Allergies records type and |
| | Record | description as well as reaction level, |
| | | date of onset and notes for each |
| | | allergy recorded. |
| | Medications History | Medications for patient, aggregate |
| | and Search View | view, all entries, user can update by |
| | | selecting an existing one or add a |
| | | new one. |
| | Add/Update Meds | Entry supports discreet dosage entry |
| | | as well as text notes for each |
| | | medication entry. |
| | | User defined medication lists are |
| | | easily managed and increased as |
| | | needed. |
| | Vitals History and | Aggregate view of each service date |
| | Search View | when vitals were taken. |
| | Add New Vitals | Blood pressure entry supports, |
| | Record per | sitting, lying and standing entries. |
| | encounter | |
| | | Temperature |
| | | Respiration |
| | | Height |
| | | Weight |
| | Disability History | Main view can support more than one |
| | and Search View | entry, each with it's own case #. |
| | Add New/Update | Enter Indicators for cause of |
| | Disability Record | disability |
| | | Enter Case number, which groups the |
| | | encounters concerned with this |
| | | injury or illness. |
| | | Enter Date of Injury |
| | | Enter and track Unable to Work Dates |
| | | Enter and track Transitional Work |
| | | Dates |
| | | List Restrictions for work |
| | | List RTW Date |
| | | Record disability Rating, with body |
| | | parts affected and temporary or |
| | | permanent Indicators. |
| | Heath Risk | Full data collection for Patient's |
| | Assessment- Past | History and Lifestyle to assess risk |
| | History | level. |
| | | Past Incidents of Illness recorded |
| | | with Results and Notes |
| | Family History and | Family History for an unlimited |
| | Search View | number of entries and relationships |
| | | Notes for each entry, or person |
| | | related along with disease and status |
| | | of disease. |
| | Social History | Occupational, Tobacco, Alcohol and |
| | | Drug Use Assessment |
| | Add/Update Social | Captures Occupational type, duties, |
| | History | length of work in this area, |
| | | Captures type of tobacco, amounts |
| | | and how long. |
| | | Captures types of alcohol, how often |
| | | and how long. |
| | | Captures types of drug use, how |
| | | often and how long. |
| | Lifestyle Record | Covers Patient's Daily activities, diet |
| | Search and View | and eating habits, vitamins and |
| | | supplements. |
| | Add/Update | Diet in discreet data terms of fats, |
| | Lifestyle Records | proteins, sugars, types of foods, and |
| | | caffeine/cola intake. |
| | | Exercise, record different activities, |
| | | how often and how long. |
| | | Supplements record, for better food |
| | | value and for patient's that treat |
| | | themselves in alternate methods. |
| | | User defined entries for Assessment |
| | | lists like activities, supplements, etc. |
| | ROS- Review of | Five screens of the classic “seven” |
| | Systems Search | body systems inquiry, using positive |
| | | and negative response with text |
| | | notes for each entry. |
| | Begin Basic Exam | Records 20 Generally examined |
| | | areas, to determine what systems to |
| | | explore. |
| | Exam General A | 100 discreet fields of response |
| | | indicators, can be filled out on pen- |
| | | based wireless, point-and-click. |
| | Exam General B | Attaches to specific |
| | | Encounter/Service Date |
| | Neuro Exam | Physician uses Exam parts only when |
| | | necessary. |
| | Cranial Exam | Physician uses Exam parts only when |
| | | necessary. |
| | Women Only Exam | Records information for a woman's |
| | | reproductive specific info, one exam |
| | | per each encounter. |
| | | Records Last PAP Date, Last PAP |
| | | results, and Notes for PAP. |
| | | Records Last Mammogram Date, |
| | | Mammogram results if positive, and |
| | | Notes for Mammogram. |
| | | Records LMP |
| | | Records number of pregnancies, |
| | | miscarriages, abortions, still births |
| | | and children. |
| | Men Only | Reproductive Exam for Men |
| | | Records discreet info for Last PSA |
| | | and Results notes. |
| | Physician's Notes | Initial Narrative |
| | and Narratives | |
| | | Interim Narratives |
| | | Final Narrative |
| | | Admit Summary Report |
| | | Discharge Summary Report |
| | | Surgery Report |
| | SOAP Notes - | Choose the current encounter to |
| | | attach notes to or generate a new |
| | | one for any date. |
| | | Subjective, Objective and |
| | | Assessment can be user defined or |
| | | ICD Diagnosis Codes with |
| | | descriptions and notes for each. |
| | | Plan can be user-defined codes or |
| | | CPT/HCPCS for Planning entries. |
| | | Overview of all SOAP notes for |
| | | chosen encounter, user/date/time |
| | | stamped, printable. |
| MPI | Master Participant | Records and tracks all EON care |
| | Index | participants, with commonly |
| | | required demographics: |
| | | Universal Patient ID capable, 20 |
| | | character alphanumeric Unique ID |
| | | generated for each Participant on |
| | | entry. |
| | Master Participant | Allows user to Search by 25 |
| | Index Locator | different organizational Keys |
| | | “Types” all EON care Participants, |
| | | with single or multiple indicators, |
| | | tying the different relationships |
| | | and roles together with one |
| | | Unique Identifier. |
| | | Allows user access to enter and |
| | | manage “type” specific profiles, |
| | | additional data that applies only |
| | | to that type of Participant. |
| | | Groups all entities by |
| | | Organization, Group, Division, |
| | | Location, Department |
| | Add/Update New | Common file for all Participants |
| | Participants | can be shared across multiple |
| | | accounts and EON installations. |
| | | No redundant MPI data. |
| | | 50% of EON System Set-up is |
| | | facilitated thru the MPI. |
| | | Archives and Date/Time Stamps |
| | | each subsequent change of any |
| | | info in the Participant's Profile |
| | | MPI Common demographics |
| | | include: Name |
| | | First Name |
| | | Middle Name |
| | | Last Name |
| | | Prefix |
| | | Appellation |
| | | Alternate ID |
| | | Individual ID |
| | | Organization ID |
| | | Group ID |
| | | Division ID |
| | | Location ID |
| | | Address One |
| | | Address Two |
| | | City |
| | | State |
| | | ZIP |
| | | COUNTY |
| | | COUNTRY |
| | | TIME ZONE |
| | | E-MAIL Address |
| | | Effective Date |
| | | Termination Date |
| | | Phone #1 |
| | | Phone #2 |
| | | Phone #3 |
| | Patient Profile | Patients- full demographic profile |
| | | as described in Registration |
| | Responsible Party | Responsible Parties - all |
| | Profile | necessary guarantor data for |
| | | billing and accounting. |
| | Member Profile | a. Member Enrollment Data |
| | Dependent Profile | b. Dependent Data |
| | Provider Profile | Providers- see Provider |
| | | Credentlaling in Managed Care for |
| | | description detail |
| | Security Profile | Security (Users)- Profile data |
| | | Multiple accounts management for |
| | | access |
| | Organization Profile | Organizations' details including |
| | | Contact Names and Phones |
| | Division Profile | Divisions |
| | Location Profile | Locations |
| | Department Profile | Department details, Including |
| | | Contact Info |
| | Payer Profile | Payer Profile Details |
| | | Payer Contract entry and tracking |
| | | by Effective and Term Dates |
| | | Pre-certification, authorization, |
| | | and eligibility verification phone |
| | | number fields. |
| | | Billing defaults Including |
| | | electronic submission Indicator |
| | | and the corresponding submitter |
| | | name and file format. |
| | | Payer classifiers Source of |
| | | Payment and Payer Class. |
| | | Administrative Payer assignment. |
| | Payer Plan | Includes plan, network, coverage |
| | Assignment | ID's along with effective and |
| | | termination dates. |
| | | Ability to assigh unlimited plans. |
| | Payer Contract | Includes contract, network, |
| | Assignment | coverage ids along with effective |
| | | and termination dates. |
| | | Ability to assign unlimited plans. |
| | | Ability to restrict how often a |
| | | payer is billed for services using a |
| | | given contract based on the Billing |
| | | Parameter. |
| | Group Practice Profile | Group Practices- Lists all |
| | | associated Providers |
| | Electronic Submitter | Electronic Submitters- set-up and |
| | Profile | defaults for any e-submissions, |
| | | claims and connectivity |
| | | transactions to Clearing Houses |
| | | and Claims Processors |
| | | Ability to profile any participant |
| | | who submits EDI files for EON |
| | | functions: HCFA Claims, UB92 |
| | | Claims, Medi-Cal, 1099 (IRS). |
| | | Contact Names and Phones |
| | | File Parameters for multiple file |
| | | formats submitted. User may |
| | | submit any or all. |
| | | Settings for sequence numbers, |
| | | pass words. |
| | | Settings for any number of file |
| | | formats. |
| | Employer Profile | Employers Contact Names and |
| | | Phones |
| | Group Profile | Groups Contact Names and |
| | | Phones |
| | Network Profile | Networks Contact Names and |
| | | Phones |
| | Facility Profile | Facility details include Type of |
| | | Facility (standard codes) and |
| | | Fiscal Year settings for |
| | | accounting. |
| | Vendor Profile | Vendor Contact Names and |
| | | Phones |
| | | Billing Address |
| | | Shipping Address |
| | Personnel Profile | Personnel details include DOB, |
| | | Marital Status, Gender |
| | | State Drivers License, State |
| | | Indicator |
| | | Race, Citizenship, SSN |
| | | EEO # |
| | | Type of Resource, Personnel |
| | | Status |
| | Pharmacy Profile | Pharmacy's details include the |
| | | NABP # |
| | | Network Participation |
| | | maintenance and tracking. |
| | Fund Profile | Funds - set up funds |
| | | administrator such as banks and |
| | | TPAs |
| | | Set-up multiple accounts within a |
| | | Fund Manager |
| | | Contact Info including Name, |
| | | Email address, and Phone number |
| | | Ability to load multiple bank |
| | | accountnumbers to one fund |
| | | Assign check group id to each |
| | | account for use with check |
| | | printing software partner ACOM. |
| | | Ability to restrict check numbers |
| | | assigned from each account. |
| | | Cycle code assignment allows |
| | | grouping of accounts for check |
| | | batch processing based on date |
| | | intervals. |
| | | Next Print Date shows when |
| | | checks for an account will be |
| | | printed again. |
| | | Check Process Code indicates |
| | | whether checks for this account |
| | | will be processed to pay either |
| | | one or multiple events. |
| | Customer Profile | Contact Names and Phones |
| | | Billing Address |
| | | Shipping Address |
| Scheduling | Patient | Manages schedules and appointments |
| | Appointment | across multiple locations for any |
| | History | Practice Enterprise |
| | | Patient Central View of appointments |
| | | and Patient Appointment history |
| | | across Facilities and Providers. |
| | | Patient Frame displays all pertinent |
| | | info for a Patient you are scheduling. |
| | | You can use the Finder to bring up |
| | | the Patient's Appointment History. |
| | | You can add a person directly thru |
| | | the MPI, and schedule them, or |
| | | access anyone for scheduling directly |
| | | from the MPI. |
| | Add/Update | Search for Open Appointments by and |
| | Appointment | across Facilities. |
| | | Search for Open Appointments by and |
| | | across Providers. |
| | | Search for Open Appointments by |
| | | Calendar Date or User Specified Date |
| | | Range |
| | | Search for Open Appointments for |
| | | specific services and variable user |
| | | defined time slots. |
| | | Search for special slots for specific |
| | | Department openings. |
| | | Search for special slots for specific |
| | | Floor openings. |
| | | Search for special slots for specific |
| | | Unit openings. |
| | | Search for special slots for specific |
| | | Room openings, like Exam Rooms. |
| | | View Openings for selected searches |
| | | and choose desired appointment. |
| | | View openings with all other overlaps |
| | | and booked areas. Overlaps and |
| | | booked areas are color coded for |
| | | management, and easy viewing. |
| | | Overbooking capabilities with |
| | | warning messages. |
| | | Patient Central view allows user to |
| | | see Account balance and status when |
| | | scheduling. |
| | | Appointment generates encounter |
| | | info for Pull lists and Encounter |
| | | forms. All appointments connected to |
| | | Physician Notes, Encounters and |
| | | charges. |
| | | Can make appointments with |
| | | Personnel, like billing staff or Pre- |
| | | cert Consultants. |
| | | Allows “Wave” Scheduling |
| | | “Pending”, “Confirmed”, and |
| | | “Completed” status settings. |
| | Automated | “Reschedule” status automatically |
| | Rescheduling | guides user thru moving the |
| | Functionality | appointment to new location and |
| | | time. |
| | | Data can carry thru for search for |
| | | rescheduling or, you can change any |
| | | part of it. |
| | | “No-show” and Cancellations are |
| | | stored for tracking Patient |
| | | Appointment History. |
| | | Put a Patient on the “Wait List” with |
| | | any preferences, including Physician, |
| | | times or Services. |
| | Wait List | Wait List Management, find any and |
| | Management | all waiting details and automatically |
| | | put them in a new place when called |
| | | for. |
| | | When you've made and appointment, |
| | | during the day, for a walk-in, you can |
| | | generate the Encounter Form, by |
| | | Patient Name immediately. |
| | | Details for appointment, including |
| | | Patient Phone #'s, and Co-pay |
| | | displayed at all times. |
| | | Add a Text Comment to each |
| | | Appointment. |
| | | Add a “complaint” or reason for the |
| | | visit to each appointment. |
| | | Displays “Special Instructions” for |
| | | service, to patient in details. |
| | | Right click and Print the Patient |
| | | Appointment Update Screen for |
| | | Patient Info on next appointment. No |
| | | more handwriting little cards. |
| | | Tracks user-defined referral |
| | | indicators; Yellow Pages, friends, |
| | | doctors, etc. |
| | | Enter and track “Recall” Dates. |
| | Check Benefits | Can View Patient's Benefit Plan for |
| | when Scheduling | access to referral requirements, Co- |
| | for Referrals and | pay, etc. See Benefit Plan Summary. |
| | Authorization | |
| | needs. | |
| | Searches and | Access Schedules for Single or |
| | Views by Facility, | Multiple Physicians (unlimited) at any |
| | with Add/Update | Facility |
| | | Access Schedules for any Date Range |
| | | or block of time. |
| | | Manage any appointment on the |
| | | Facility Appointments schedule view |
| | | by clicking on it, to access Updating |
| | | capabilities. |
| | | Print any view created by right-click |
| | | and print feature. |
| | Searches and | View without Provider Name for |
| | Views by | multiple Physicians Views. |
| | Provider, with | |
| | Add/Update | |
| | | Create Views for specific types of |
| | | services: Example: all Physicals |
| | | scheduled for a week for a Provider. |
| | | Manage any appointment on the |
| | | Provider Appointments schedule view |
| | | by clicking on it, to access Updating |
| | | capabilities. |
| | | Search and locate any one existing |
| | | appointment and it's details for |
| | | Patient. |
| | Personnel | Search for and view the work |
| | Schedule View | schedules and break times set up for |
| | | any Provider or Personnel. |
| | | Search for and view the full |
| | | personnel schedule and break times |
| | | set up for any Facility. |
| | | Manage and make changes to any |
| | | schedule, day or break accessed on |
| | | the View List. |
| | | Set-up Vacation Times. |
| | | Set and Track Sick days. |
| | | Schedule for personnel such as |
| | | Receptionists and other non-care- |
| | | providers. |
| | | Scheduling Availability covers 7/24 |
| | Create New | Create Provider and Personnel |
| | Schedules | availability/schedules by using easy |
| | | templates. |
| | Monitor and | Cycle out Schedulling Templates for |
| | Change | any amount of days, weeks or years |
| | Schedules | ahead of time. |
| | Apply Templates | Apply Vacation Days within the |
| | for Long Term | template, that vary from the usual |
| | Schedules in | routine. |
| | seconds. | |
| | Scheduling Set- | Create custom Scheduling |
| | Up | parameters for any Provider or |
| | | Personnel, for any Location, even |
| | | each Floor, Unit and Room within a |
| | | Facility. |
| | Service Events | Define all of the particular Service |
| | | Events that happen in your Facility or |
| | | in multiple Facilities. |
| | | Name the event any user-friendly |
| | | term that works for your |
| | | environment. |
| | | Set any user-defined variable for the |
| | | length of the service (45, 20, 30, 60 |
| | | minutes). The Scheduler can |
| | | automatically Identify proper time |
| | | slots for these events. |
| | | Determine what Department, Floor, |
| | | Units and Rooms, and even beds, |
| | | where a particular service can be |
| | | scheduled. |
| | | Define what procedure code is |
| | | connected to this event. |
| | | Define Special Instructions for |
| | | Patients concerning this service. |
| | | Define the Resources or team of |
| | | personnel that are needed to perform |
| | | or attend this event. |
| | | Define special or specific events |
| | | custom for each Provider when |
| | | necessary. |
| | | Define materials or equipment |
| | | needed for each event. |
| | Scheduling | Create Custom Templates for each |
| | Templates | Provider |
| | | Name the Template any thing that |
| | | works for you, and set it up for any |
| | | combination of days during the week. |
| | | Create multiple templates for a |
| | | physician who works different hours |
| | | in different facilities. |
| | | Create pre-defined break times, that |
| | | can be different each day. |
| | | Create Templates for all Personnel, |
| | | such as nurses and office staff. |
| | Rooms | Create the model for your facility, |
| | | start by adding user-defined codes |
| | | for al your departments, floors, units |
| | | and rooms. Unlimited entry |
| | | supported. Small Clinic or large |
| | | hospital. |
| | | Add combinations of Department, |
| | | Floor, Unit, and Room for use in |
| | | finding specific schedule openings. |
| | | Search for any Facility-listing of |
| | | Rooms, or find a particular one, to |
| | | manage and Update. |
| | | Define the times during the day when |
| | | the rooms will be available. You can |
| | | have rooms that are available 24/7 |
| | | or just from 9-5. |
| | | Define or check current status of |
| | | room. |
| Registration | Patient Card | Find It allows Searches for Patients |
| | Frame | by a wide variety of forms and |
| | | variables. Drill downs can find any |
| | | Patient in the system by Name, DOB, |
| | | Account #, SSN, Date of Service, |
| | | Member ID, Individual, Alias, |
| | | Address and Medical Record #. |
| | Patient Find It | Finder can use any combination of |
| | | the values in the Patient Profile. |
| | | All searches use search parameters |
| | | of partial words, and use “soundex” |
| | | for names and text items. |
| | | Finder can view user defined set of |
| | | records and numbers to control |
| | | scrolling and performance. User can |
| | | choose more or less depending on |
| | | preferred views. |
| | | Finding a Patient allows the Patient |
| | | Card to Show all the most valuable |
| | | info that Physicians and staff want to |
| | | see all the time while viewing and |
| | | managing the Patient record |
| | | longitudinally. |
| | | Patient Card stays visible throughout |
| | | all Patient central point of Serrvice |
| | | functions. |
| | | Central to all Patient Views, Patient |
| | | Name, Address, Individual ID, SSN, |
| | | Primary Care Provider, Co-pay for |
| | | Primary, Account Balance, Account |
| | | Status. |
| | Add New Patient | View of Patient Demographics: From |
| | | MPI and Patient Profile combined to |
| | | comprise 90% of all required data |
| | | capture, in one screen. |
| | | Common demographics, Including: |
| | | date of birth, marital status, |
| | | employment status, sex, billing |
| | | defaults per Patient. |
| | Patient Admin | 99% of all Patients can be |
| | | effectively Registered in the first |
| | | screen, in under 30 seconds. |
| | | Over 120 unique fields of data |
| | | captured for the Registration |
| | | process. |
| | | Individual ID is available for up to 20 |
| | | characters, so if the Patient does not |
| | | have a Social # then the field can |
| | | accept other Ids and SSN as well.. |
| | | Specific SSN field is pre-formatted |
| | | and does not allow duplicates. |
| | | Perform Primary Care Provider |
| | | Assignment |
| | | Record Patient's current or favorite |
| | | Pharmacy for call-ins and E- |
| | | prescriptions. |
| | | Name is captured as Name, but also, |
| | | as First Middle and Last, discreet |
| | | fields. |
| | Account Set-Up | Account Set-up is automatic with |
| | | unique ID account ID generation and |
| | | Effective Dates and billing |
| | | Parameters automatically filed on |
| | | first entry of Patient. |
| | | Assigns the guarantor on creation of |
| | | Patient Profile, from user entry or |
| | | defaults to patient. |
| | Transfer an | Transfer an account and all it's |
| | Account | financial records and responsibilities |
| | | to another guarantor, in seconds. |
| | Terminate an | Terminate an Account, when no |
| | Account | balance is present. |
| | Manage Account | Change the Account Status, which |
| | Status | can turn the statement billing “off” |
| | | or “on”. |
| | Change Billing | Change the Statement Billing |
| | choices and | Parameters, which allows the user to |
| | Parameters | change the dates and frequency the |
| | | Patient or Guarantor is billed for |
| | | from Patient Statement. |
| | Employment | Enter the Patient's Employment |
| | | Record |
| | | Includes Employment Date, Employer |
| | | Name. |
| | | Also captures Nature of Business, |
| | | and specific duties or title of |
| | | Employee. |
| | Military Info | Enter the Patient's Military Service |
| | | Card information |
| | | Captures Service Branch, Service |
| | | Grade, Service Status, Program |
| | | Participation and Effective and Term |
| | | Dates. |
| | Insurance | Insurance History and Present |
| | Coverage | records displayed in order of Priority. |
| | | Can Update or access to Verify |
| | | Eligibility for any one of them from |
| | | main view. |
| | Add/Update | Enter the Patient's coverage(s), |
| | Coverage | unlimited if necessary |
| | | Records by Effective and Termination |
| | | Date so the user can store previous |
| | | plan info for any priority (primary, |
| | | secondary, tertiary) |
| | | Unlimited ability to add additional |
| | | coverages (Worker's Comp, FLEX |
| | | Plans, etc.) |
| | | Record for each Payer: specific Plan, |
| | | Product, Network, Coverage and |
| | | Coverage Type |
| | | Capture the Insured data, whether |
| | | Self or other Relationship, with |
| | | Member ID. |
| | | Group ID |
| | | Edits the user, to prevent incorrect |
| | | coverage entries: cannot change an |
| | | insurance that has open items left for |
| | | receivables improperly. All required |
| | | fields for billing must be present. |
| | | Edits for valid Member Ids like MediCal. |
| | Plan Summary | Search for and attach a Plan |
| | | Summary for each insurance plan |
| | | recorded, for access to requirements, |
| | | like referrals, co-pays and |
| | | deductibles. |
| | | Plan ID |
| | | Product ID |
| | | Product Name |
| | | Coverage ID |
| | | Coverage Name |
| | | Co-Pay Amounts |
| | | Annual Deductibles |
| | | Annual Coinsurance |
| | | Annual Out-of Pocket |
| | | Lifetime Maximum |
| | | Annual Deductibles Met Amounts |
| | | Annual Coinsurance Met Amounts |
| | | Annual Out-of Pocket Met Amounts |
| | | Lifetime Maximum Met Amounts |
| | Plan Summary | Identify and record benefit items |
| | Details | that require Referrals, |
| | | Authorizations, Not covered, etc. Or |
| | | have special limits on monies, |
| | | expenses, occurrences, etc. |
| | Extended | Race |
| | Registration | |
| | | Ethnicity |
| | | Number of Children |
| | | Number in Household |
| | | Salary |
| | | Driver's License # |
| | | Patient Status |
| | | Co-Pay |
| | | Patient Salary |
| | Chart Tracker | Enter and track Medical Record #s to |
| | History | coordinate with paper charts, |
| | | additional to the EMR. |
| | Chart Check In- | Check in and Check Out allows user |
| | Out | to assign Reasons for Medical Record |
| | | use, and User/Date/Time stamp for |
| | | historical record usage. |
| | Contacts | Enter as many contacts as you need |
| | | for any Patient, for emergency and |
| | | communication purposes. Example: |
| | | Parents, Guardians, Child Care |
| | | Contact Name |
| | | Relationship to Patient |
| | | Gender |
| | | Home Phone |
| | | Work Phone |
| | Patient Content | Special Picture ID's can be stored for |
| | | Patient and viewable on-line as |
| | | thumbnail in the Patient Admin |
| | | screen. |
| | Manage and | Upload any multimedia file and |
| | Exchange Content | attach to Patient Record and store in |
| | with other | database for viewing, listening, |
| | Providers | storing, and exchange of information |
| | | about the patient. |
| | | Files are Typed and categorized and |
| | | can be any kind of file that a |
| | | browser, with or without plug-ins |
| | | can activate. |
| | | Download content for exchange. |
| | | Examples are scanned documents, |
| | | pictures, sound files, read-only, such |
| | | as lab test results. |
| | Comments | View of all historical Notes, this field |
| | | can 64,000 bytes per note. |
| | | All Notes are Date/Time/User |
| | | stamped on entry and cannot be |
| | | deleted or changed by users. |
| | Message Bar | Up□ and Down□ Arrows let you |
| | Viewer | scroll through text messages and |
| | | notes for the Patient you have |
| | | accessed. |
| | Add New Message | From the Message bar you can add |
| | | new Notes or Comment while using |
| | | any other Patient Central function or |
| | | feature. |
| Authorizations | Add Physician/ | Create and Track Managed Care |
| | Provider Referral | Referrals In a Patient Central View |
| | Request | |
| | | Enter Referrals To and From the Primary |
| | | Care Provider, or Specialist to Specialist |
| | | Referrals tagged with Payer (specific to |
| | | what Patient is eligible for) Date and |
| | | Reason |
| | Specify Services | Specify any line item(s) for detailed |
| | on Referral | referral process, such as Physical |
| | | Therapy treatments with multiple |
| | | procedure codes |
| | | Each line item has a From and Thru Date |
| | | for referrals that expire |
| | | Each requested procedure can have |
| | | Multiple Diagnosis codes |
| | | Each line item has a revenue code that |
| | | can be applied. |
| | | Each procedure can use up to four |
| | | modifiers |
| | | Each procedure can use Length, Unit |
| | | and Occurrence calculations |
| | | Each item can have a requested amount |
| | | and record an approved amount. |
| | | Each item has the ability to be approved |
| | | or denied, so each line item can be |
| | | processed properly within the request |
| | Approve or | Approved Referrals require an |
| | Deny, full or | Approval/Auth ID, and can be used then |
| | partial | in other applications like Encounters |
| | | and Billing |
| | Add | Create Requests for Authorizations or |
| | Authorization/Pre- | Pre-Certifications for services |
| | certification | |
| | Request | |
| | | Enter Requests for any Provider, to any |
| | | Payer on the Patients list of coverage |
| | | Referrals Date and Reason |
| | | Each line item has a service code that |
| | | can be applied. |
| | Specify Services | Specify any line item(s) for detailed |
| | to be certified or | treatments with multiple procedure |
| | Authorized | codes such as surgery |
| | | Each line item has a From and Thru |
| | | Date for exact application of the Pre- |
| | | Cert |
| | | Each requested procedure can have |
| | | Multiple Diagnosis codes |
| | | Each procedure can use up to four |
| | | modifiers |
| | | Each procedure can use Length, Unit |
| | | and Occurrence calculations |
| | | Each item can have a requested amount |
| | | and record an approved amount. |
| | | Each item has the ability to be approved |
| | | or denied, so each line item can be |
| | | processed properly within the request |
| | Approve or | Approved Pre-Certs and Authorizations |
| | Deny, full or | require an Approval/Auth ID, and can |
| | partial | be used then in other applications like |
| | | Encounters and Billing |
| | | Contact Follow-up Name |
| | | Contact Phone |
| Medical Records | | Supports aggregate as well as |
| | | encounter specific views of clinical |
| | | data. |
| | Health History | Problem List view, updated from |
| | | previous encounters' diagnoses, |
| | | with date and status. |
| | Allergies History | Allergies aggregate view, unlimited |
| | and Search View | entry ability and accrue over all |
| | | entries for all encounters. |
| | Add/Update Allergy | Allergies records type and |
| | Record | description as well as reaction level, |
| | | date of onset and notes for each |
| | | allergy recorded. |
| | Medications History | Medications for patient, aggregate |
| | and Search View | view, all entries, user can update by |
| | | selecting an existing one or add a |
| | | new one. |
| | Add/Update Meds | Entry supports discreet dosage entry |
| | | as well as text notes for each |
| | | medication entry. |
| | | User defined medication lists are |
| | | easily managed and increased as |
| | | needed. |
| | Vitals History and | Aggregate view of each service date |
| | Search View | when vitals were taken. |
| | Add New Vitals | Blood pressure entry supports, |
| | Record per | sitting, lying and standing entries. |
| | encounter | |
| | | Temperature |
| | | Respiration |
| | | Height |
| | | Weight |
| | Disability History | Main view can support more than |
| | and Search View | one entry, each with it's own case #. |
| | Add New/Update | Enter Indicators for cause of |
| | Disability Record | disability |
| | | Enter Case number, which groups |
| | | the encounters concerned with this |
| | | injury or illness. |
| | | Enter Date of Injury |
| | | Enter and track Unable to Work |
| | | Dates |
| | | Enter and track Transitional Work |
| | | Dates |
| | | List Restrictions for work |
| | | List RTW Date |
| | | Record disability Rating, with body |
| | | parts affected and temporary or |
| | | permanent indicators. |
| | Heath Risk | Full data collection for Patient's |
| | Assessment- Past | History and Lifestyle to assess risk |
| | History | level. |
| | | Past Incidents of Illness recorded |
| | | with Results and Notes |
| | Family History and | Family History for an unlimited |
| | Search View | number of entries and relationships |
| | | Notes for each entry, or person |
| | | related along with disease and |
| | | status of disease. |
| | Social History | Occupational, Tobacco, Alcohol and |
| | | Drug Use Assessment |
| | Add/Update Social | Captures Occupational type, duties, |
| | History | length of work in this area, |
| | | Captures type of tobacco, amounts |
| | | and how long. |
| | | Captures types of alcohol, how often |
| | | and how long. |
| | | Captures types of drug use, how |
| | | often and how long. |
| | Lifestyle Record | Covers Patient's Daily activities, diet |
| | Search and View | and eating habits, vitamins and |
| | | supplements. |
| | Add/Update | Diet in discreet data terms of fats, |
| | Lifestyle Records | proteins, sugars, types of foods, and |
| | | caffeine/cola intake. |
| | | Exercise, record different activities, |
| | | how often and how long. |
| | | Supplements record, for better food |
| | | value and for patient's that treat |
| | | themselves in alternate methods. |
| | | User defined entries for Assessment |
| | | lists like activities, supplements, etc. |
| | ROS- Review of | Five screens of the classic “seven” |
| | Systems Search | body systems inquiry, using positive |
| | | and negative response with text |
| | | notes for each entry. |
| | Begin Basic Exam | Records 20 Generally examined |
| | | areas, to determine what systems to |
| | | explore. |
| | Exam General A | 100 discreet fields of response |
| | | indicators, can be filled out on pen- |
| | | based wireless, point-and-click. |
| | Exam General B | Attaches to specific |
| | | Encounter/Service Date |
| | Neuro Exam | Physician uses Exam parts only |
| | | when necessary. |
| | Cranial Exam | Physician uses Exam parts only |
| | | when necessary. |
| | Women Only Exam | Records information for a woman's |
| | | reproductive specific info, one exam |
| | | per each encounter. |
| | | Records Last PAP Date, Last PAP |
| | | results, and Notes for PAP. |
| | | Records Last Mammogram Date, |
| | | Mammogram results if positive, and |
| | | Notes for Mammogram. |
| | | Records LMP |
| | | Records number of pregnancies, |
| | | miscarriages, abortions, still births |
| | | and children. |
| | Men Only | Reproductive Exam for Men |
| | | Records discreet info for Last PSA |
| | | and Results notes. |
| | Physician's Notes | Initial Narrative |
| | and Narratives | |
| | | Interim Narratives |
| | | Final Narrative |
| | | Admit Summary Report |
| | | Discharge Summary Report |
| | | Surgery Report |
| | SOAP Notes - | Choose the current encounter to |
| | | attach notes to or generate a new |
| | | one for any date. |
| | | Subjective, Objective and |
| | | Assessment can be user defined or |
| | | ICD Diagnosis Codes with |
| | | descriptions and notes for each. |
| | | Plan can be user-defined codes or |
| | | CPT/HCPCS for Planning entries. |
| | | Overview of all SOAP notes for |
| | | chosen encounter, user/date/time |
| | | stamped, printable. |
| Admissions, | Current Admissions | Search for Admissions by a wide |
| Discharges, | History and Search | variety of variables. Drill downs can |
| Transfers | View | find any Patient in the system by |
| | | Name, Admit Date, Account #, SSN, |
| | | Admitting Physician, Room #, |
| | | Medical Record #. |
| | | Finder can view user defined set of |
| | | records and numbers to control |
| | | scrolling and performance. |
| | | Finding a Patient allows the Patient |
| | | Card to show all the most valuable |
| | | info that Physicians and staff want |
| | | to see all the time while viewing |
| | | and managing the Patient record |
| | | Longitudinally. |
| | Add/Update | Assign a Medical Record |
| | Admission | |
| | | See if the Patient has had a recent |
| | | Inpatient or Outpatient episode of |
| | | care with this Hospital or Facility. |
| | | Record the Admitting Diagnosis |
| | | Record the Type of Service |
| | | Admissions can cross multiple |
| | | Facilities |
| | | Record Admitting Physician |
| | Transfer Patient | Transfer a Patient from one room to |
| | | another, during the stay. |
| | | Records the From and Thru |
| | | Date/Time for the occupation of the |
| | | Room. |
| | Transfer History | Track/View a history of the Room |
| | View | Occupation for the Patient. |
| | Facility Manager | Rooms Management for all available |
| | | rooms that can be used for Patient |
| | | Stays. |
| | | Monitor status of Available Rooms, |
| | | Occupied Rooms and Rooms waiting |
| | | to be cleaned. |
| | Process Discharges | Anyone with an open admission to |
| | | be Discharged can be managed |
| | | from Current Admissions. |
| | | You can Update the Discharge |
| | | Record. |
| | | Discharge to Home or another |
| | | Facility. |
| | | Track teaching/education |
| | | requirements. |
| | Patient Central | Across Facilities you can Search and |
| | view of all | View an admission, the discharge |
| | Admissions | data, if applicable, and the transfer |
| | | history. Shows all Admission for a |
| | | single Patient, accessed in Patient |
| | | Card |
| Orders | Orders History by | Finding a Patient with the Patient |
| | Patient Admission | Card to show all the most valuable |
| | | info that Physicians and staff want |
| | | to see all the time while viewing |
| | | and managing the Orders. |
| | | Finder can view user defined set of |
| | | records and numbers to control |
| | | scrolling and performance. |
| | | Once Patient is chosen view all |
| | | current orders, and status of those. |
| | | Create new or additional Orders. |
| | | Monitor Order Status |
| | Add/Update | Create custom orders by Physician, |
| | Orders | Personnel, automatically date time |
| | | stamps all entries. |
| | | Choose Department and |
| | | automatically get all the procedures |
| | | that can be done by that |
| | | department. |
| | | Select times for tests and services. |
| | | Records Notes for each order. |
| | Process Order | Change status to Completed, |
| | Status | Discontinued, or Patient Refused. |
| | | Process verifies Dates, amounts and |
| | | if completed, sets up billing for |
| | | item. |
| | | Monitor orders that did not occur on |
| | | time. |
| | | Creates iterative history of order, on |
| | | update. |
| | | When Updating you can view the |
| | | iterative history, but can't change it, |
| | | you can only update the most recent |
| | | order version. |
| Diagnostic | History and Search | Patient Central, controlled by Patient |
| Tests | View of Ordered | Card, user can access Requested |
| | Tests | Orders for any Patient on same |
| | | screen. |
| | Add/Update Orders | Attach to Encounter or Service Date |
| | | Ability to pull the rendering/ordering |
| | | physician from the encounter that is |
| | | selected instead of having to re- |
| | | enter the information |
| | | Order any type of test, including |
| | | clinical, x-rays, MRI, EKG, etc. |
| | | Search for CPT/HCPCS by Type and |
| | | Category for easy cut downs. |
| | | All diagnostic HIPAA compliant |
| | | procedure codes available to create |
| | | order. |
| | | Each test record holds up to four |
| | | diagnosis codes, since some test |
| | | orders require more than one. |
| | | Captures Rendering and Ordering |
| | | Provider |
| | | Facility where test occurs. |
| | | Specimens can be recorded at |
| | | Ordering location or Test location, |
| | | like an outside Lab, with Collection |
| | | Date, Specimen # and Specimen |
| | | Type. |
| | | Ordered Tests can be updated until |
| | | results are posted, then they cannot |
| | | be changed. |
| | | Record Requisition # up to 20 |
| | | alphanumeric characters. |
| | Post Results | Access all waiting tests for manual |
| | History and Search | posting of results. Patient Central |
| | View | View. |
| | Add/Update | Post Diagnostic Test Date (actually |
| | Results | performed as opposed to ordered) |
| | | Reporter Name |
| | | Post details for discreet results |
| | | records. Can do single tests or |
| | | panels. |
| | | Post what the normal range is for |
| | | the test. |
| | | Abnormal Indicators |
| | | User can define new measurement |
| | | indicators and set normals for any |
| | | new test that is developed. |
| | | Test Results Notes, 64,000 byte |
| | | capability. |
| | Load PDF Results, | Choose a test and load a file from |
| | or Images for each | the lab. Could be a PDF for reports or |
| | Test | a text file, also loads and displays |
| | | any images for Radiology that are |
| | | browser compliant. If not browser |
| | | compliant, it can still store it in the |
| | | database. |
| | Download Results | Send by e-mail to exchange with |
| | files | other providers. |
| | Review Results | Special screen only for physicians. |
| | | Secured level. Updates for physician |
| | | that he/she has read report. |
| | | Physician can access by groups of |
| | | Completed/Read (posted results for |
| | | he/she to view) or Completed and |
| | | Not Read. |
| Prescriptions | Prescription History | Patient Central view gives you 9 |
| | and Search View | different sorting and search criteria |
| | | to locate any existing prescription |
| | | for a Patient. |
| | | User controls search results for |
| | | groups of prescriptions and |
| | | performance |
| | Add/Update | Write prescriptions in sets of 10 |
| | Prescriptions | discreet data fields. |
| | | Physician finder can use any |
| | | Physician in the system. |
| | | User can define and manage lists for |
| | | Routes, Dose, Units and Frequency |
| | | Can use NDC or Org specific Codes, |
| | | HIPAA compliant |
| | | Drug Finder can sort thru unlimited |
| | | database entries for proper coding. |
| | | Search and Access Class, Subclass |
| | | and Generics. |
| | | Set Refills |
| | Print RX | Easy to find menu button activates |
| | | print of any single RX. |
| | | User can manage the format and |
| | | display of the printed version from |
| | | the Reporting Admin area. Allows |
| | | custom script print-outs. |
| Billing | Encounters by | Billing provides three different types |
| | Patient History and | of format billing for any Heathcare |
| | Search View | Service and any Payer, according to |
| | | Nationally Standardized Formats. All |
| | | bills can be printed and sent |
| | | electronically as needed. |
| | Review any Existing | Patient Central view can pick up |
| | Encounters | scheduled events for entry of charges |
| | | so it flows from Patient entry into |
| | | office to payment, or you can |
| | | generate a new encounter for those |
| | | not on the schedule, like walk-ins. |
| | Add/Update | Encounters scheduled for today, are |
| | Encounters | separate and at the top of the screen |
| | | so user can find them easily. |
| | | All patient Encounters, with Date of |
| | | Service, Status and other pertinent |
| | | info are indexed by history, for |
| | | updates and review when |
| | | appropriate. |
| | | From Date, Thru Date and Time of |
| | | Appointment can be view when |
| | | entering, or updated. |
| | | Ability to proactively or retroactively |
| | | assign Case ID # to any encounter |
| | | Ability to reference and enter up to 4 |
| | | diagnosis codes by code or |
| | | description for quick and accurate |
| | | entry |
| | | Ability to connect encounter with |
| | | proper Referrals and decrement use |
| | | of Referral |
| | | Ability to connect encounter with |
| | | proper Authorization and Pre-Cert |
| | | info and decrement use of |
| | | Authorization |
| | | Ability to Assign Ordering Physician |
| | | for Lab charges entry |
| | | Assign Rendering Physician or this |
| | | information will be auto-populated |
| | | from scheduled event for quick |
| | | charge entry |
| | | Ability to assign Program Code, user- |
| | | defined, for items that are part of |
| | | Programs the facility offers where |
| | | participation is tracked. Examples are |
| | | Enabling, Family Planning and |
| | | Counseling programs. |
| | | Ability to assign referring provider |
| | | for compliance to HCFA billing |
| | | requirements |
| | | Ability to Assign a Special Pay-to |
| | | Provider for an encounter, that is |
| | | different from the default. |
| | Specify Encounter | Ability to enter an unlimited number |
| | Charge Lines | of service lines |
| | | Ability to reference and enter CPT4 |
| | | and HCPCS procedure codes by code |
| | | or description for quick and accurate |
| | | entry |
| | | Default for Place of Service |
| | | Defaults Type of Service according to |
| | | procedure code entered |
| | | Length, Occurrence, and Unit Fields |
| | | Ability to view diagnosis codes for |
| | | quick and accurate entry of |
| | | diagnostic relationship code pointers |
| | | Automatically reads procedure code |
| | | charges by Facility and Provider |
| | | combinations |
| | | Automatically reads Fee/Rate |
| | | Schedules by Facility, Provider |
| | | Contract combinations |
| | | 4 Modifiers fields available |
| | | Charge Codes can be entered and set |
| | | to perform various functions such as |
| | | not allowing a certain item to go on |
| | | the HCFA but go straight to the |
| | | Patient's responsibility, or stopping a |
| | | charge for a lab test that was invalid |
| | | and needs to be redone. |
| | | Charge codes available to stop the |
| | | item from going out on the Patient |
| | | Statement at all, by line item. |
| | | Rendering Service Facility, including |
| | | the ability to specify different |
| | | Facilities on various line items in |
| | | single encounter record |
| | | Comments for each line item are |
| | | available, the size of 35 characters. |
| | | Since HCFA allows a small note that |
| | | size for printed line item remarks, |
| | | you can use this field for |
| | | documentation items. |
| | | Process calculates Expected Payment |
| | | Amounts for use in remittance and |
| | | Collections. |
| | | Process can update if Insurance has |
| | | been added and roll back Patient |
| | | Billing to proper insurance. |
| | | Process can validate code linkage. |
| | | Process can calculate Medicare |
| | | Expected Payments. |
| | Patient Bill | Print walk-out bill on demand for any |
| | | encounter, includes a receipt record |
| | | for any payments made that day. |
| | HCFA Process | Process single encounters to single |
| | | HCFA. |
| | | Process all encounters for a all |
| | | patients in a given user-defined date |
| | | range. |
| | | Process HCFA's in Job Request wrap |
| | | for background process and |
| | | monitoring |
| | | HCFA Process tracks job ID, job |
| | | description, job status, process |
| | | status, who initiated the job and for |
| | | which account, along with creation |
| | | date and timestamp. Also tracks |
| | | process ID, start date and time and |
| | | completion date and time. |
| | HCFA Print | Print or adjust HCFA's online |
| | | Review HCFA Print image On Line |
| | | and Print on Demand |
| | | Print batches of HCFAs onto claim |
| | | form, and reprint on demand when |
| | | necessary. |
| | HCFA Adjust Bill | Ability to Adjust HCFA, and make a |
| | | new “snapshot”, (complete iterative |
| | | version) of the adjusted bill, while |
| | | keeping an archive of the original |
| | | bill. |
| | | HCFA Claim Format Edit Capabilities, |
| | | to align with any printer, adjust fonts |
| | | for scanners. |
| | HCFA Electronic | HCFA Electronic File creation by Date |
| | Batch Creation and | Range, current NSF 3.1 file format |
| | Management | available, can also still support 2.0 |
| | | and up |
| | | User can Define Special Rules For |
| | | Editing Electronic File format, so use |
| | | any clearing house desired for |
| | | processing or direct to Payer |
| | Download E-files for | Ability to create all Payers in a single |
| | Submission | batch, for clearing-houses, or file for |
| | | single Payer submission. |
| | | Multiple clearing-houses can have |
| | | different file format versions. |
| | | History of Claims file created, with |
| | | file name, messages, content, easily |
| | | accessible in one screen. |
| | | Electronic Claims files content are |
| | | stored in the database, so you can |
| | | recreate them any time for |
| | | transmittal. File can't get “lost”. |
| | | Great for audit trail. |
| | | Error message reports are |
| | | immediately available online for each |
| | | e-file process |
| | | Content-of file can be viewed on-line |
| | | as HTML view. |
| | | Ability to print a demand bill for |
| | | patient for any encounter service |
| | | Encounters are displayed for selected |
| | | patient by date of service and also |
| | | display the facility and provider of |
| | | service as well as the user who |
| | | entered the encounter. |
| | | Demand bill reflects services |
| | | provided on given date along with |
| | | any patient payment information |
| | | Patient bill can be printed and given |
| | | to patient for their records |
| | Provider List Bill | Managed Care invoices can group |
| | Processing | Members and services from Plans |
| | | and bill monthly or quarterly (user- |
| | | defined billing parameters depends |
| | | on set-up per Payer) for Capitated or |
| | | “per member” billing. |
| | | Create bill by Date Range for a Pay-to |
| | | Provider, for all Payers |
| | | Create Single Payer bill |
| | | Encounter billing can be |
| | | accommodated here. ASCII file |
| | | extracts for encounters sent |
| | | electronically can be derived from |
| | | this data, per payer when necessary. |
| | | Set-up-Providers as Payers and |
| | | create Provider-to-Provider Billing as |
| | | in the case of Labs billing a Hospital |
| | | for services this month. |
| | UB92 Bill Process | Process single encounters to single |
| | | UB92, entered thru encounters. |
| | UB92 Print | Print any Single or Batch set of UB |
| | | bills. Reprint as necessary. |
| | UB Adjust Bill | Create Adjustments and corrections |
| | | to bill info and reprocess for sending |
| | | electronically or reprinting. |
| | UB92 Electronic | UB92 data “snapshot” and Electronic |
| | Batch Creation and | File creation by Date Range, current |
| | Management | UB Version 5.0 file format available |
| | | User can Define Special Rules For |
| | | Editing Electronic File format, so use |
| | | any clearing house desired for |
| | | processing or direct to Payer |
| | | Ability to create all Payers in a single |
| | | batch, like for clearing houses, or file |
| | | for single Payer submission. |
| | | Multiple clearing houses can have |
| | | different file format versions |
| | | History of Claims file created, with |
| | | file name, messages, content, easily |
| | | accessible in one-screen. |
| | Download E-files for | Electronic UB Claims files content are |
| | Submission | stored in the database, so you can |
| | | recreate them any time for |
| | | transmittal. File can't get “lost”. |
| | | Great for audit trail. |
| | | Error message reports are |
| | | immediately available online for each |
| | | e-file process |
| | | Content of file can be viewed on-line |
| | | as HTML view. |
| | | Patient Statements can be produced, |
| | | in color, for a single account on |
| | | demand, display on line and print |
| | | Outsource Printing and Mailing |
| | | Possible |
| | | Current Charges by line item with |
| | | Procedures |
| | | Aging Balances 30, 60, 90, 120 days |
| | | Responsible Party Billing (family |
| | | bills) |
| | | Archived Patient Statements |
| | | Can Reprint Batch or Single |
| | | Statement |
| Accounting | Receipts Manager | Access to processing for all Receipt |
| | | batches, all receipts, Daily Close Out, |
| | | by or across Facilities |
| | Receipt Batch | Default screen monitors all open |
| | History with | batches, gives warning when closing |
| | Search | and balancing is overdue. |
| | | List of Batches by Facility, sort by |
| | | Open, Voided and Closed. |
| | | Access and Review any Open Receipt |
| | | Batch |
| | Open Batch | Open a new batch or batches for a |
| | | Facility. |
| | | Batches have a unique number with |
| | | Julian date, and batch # for date for |
| | | that facility. |
| | | Set user-defined parameters for how |
| | | many batches you can have open at |
| | | one time. |
| | | Research on-line the history of all |
| | | entries in a batch. |
| | Add/Update | Post payments from Payers, Patients |
| | Receipts | or Customer type proflies. This |
| | | accommodates Healthcare Services |
| | | and Administrative Billing |
| | | receivables posting applications. |
| | | Line-item posting system posts all |
| | | payments as credits to the paying |
| | | entity until allocated. |
| | | Receipts tracks allocations, original |
| | | amount and amount still left |
| | | unallocated. |
| | | Post several types of-Payments |
| | | including, cash, personal checks, |
| | | specific credit card payments, |
| | | Insurance Checks, Company checks, |
| | | Electronic Fund Transfers, Other |
| | | Enter User-defined Cash ID for items |
| | | that stamped or tagged when |
| | | processed or have a Lockbox ID |
| | | already on them. |
| | | Enter Credit Card Payments with |
| | | Card #, Expiration Date and |
| | | Authorization Number (reference). |
| | | Enter check # for all check types |
| | | Tag with Program Code, user-defined |
| | | such as Enabling Services, Family |
| | | Counseling, etc. |
| | | Comments field available for each |
| | | receipt. |
| | | Date/Time/User Stamp for all |
| | | entries. |
| | Daily Close Out | For each batch, run a close out that |
| | (Close Batch) | totals all receipts in Payment Type |
| | | Groups and sends total to Online |
| | | screen view |
| | | Daily Close Worksheet View can be |
| | | printed, right click or use Daily close |
| | | Out Worksheet report, for balancing |
| | | drawer and checking cash receipts. |
| | | If monies do not match, and you |
| | | want to close anyway, enter and |
| | | track variances in drawer vs. posted |
| | | amounts. |
| | | Daily Close uses user defined |
| | | settings for Year-to-Date cash |
| | | reporting. Can support any fiscal |
| | | year settings. |
| | | For each batch, log deposit number |
| | | deposit date, fund and fund account |
| | | number. |
| | Void Batch | Void Batches, clears all for reposting. |
| | | Update Receipts for corrections |
| | | before batch is closed. Can change |
| | | necessary fields to correct all posting |
| | | mistakes before Closing. |
| | Retro Date Batch | When posting monies that go into |
| | | previous days, after closing the |
| | | balanced batch, just Retro Date the |
| | | entries for moving revenue into |
| | | proper months. |
| | Transfer Receipts | Transfer a receipt that was posted to |
| | | the wrong person to another person. |
| | | Transfer a Payer Payment directly to |
| | | the Patient Account. |
| | | Transfer a Payer Payment to another |
| | | Payer, such as administrative Payer, |
| | | for accurate posting. |
| | | Transfer a full amount or partial |
| | | amount. |
| | | Undo the Transfer, if incorrect. |
| | | All Transfer Transactions are stored |
| | | iteratively and tracked for accurate |
| | | accounting. |
| | Patient Account | Total History of all transactions |
| | History | concerning this account and any |
| | | other Patient this person may be |
| | | responsible for. |
| | | View of Date Last Statement went |
| | | out, Current Account Status, and |
| | | people included under this account. |
| | | All Patients can also be viewed |
| | | separately, so you don't have to |
| | | know the guarantor to final an |
| | | account. |
| | | Patient Account History is Patient |
| | | Central so you can access it by |
| | | Name, ID, Address, and much more. |
| | Payment History | All payments made by the patients |
| | | and guarantors for this account are |
| | | listed. |
| | | Drill down available on each |
| | | payment gives receipt allocation |
| | | details, where it was applied and |
| | | when. |
| | Services History | See history by Open and Billed items, |
| | | or by ALL for total view. |
| | | View of services allows sorts on any |
| | | display field, including sort by |
| | | Facility, Patient, Dates of Service, |
| | | Procedure code. |
| | | Drill down on each line item for |
| | | summary of balances, adjustments |
| | | and payments, with current item |
| | | status. |
| | | Further details list all payments, |
| | | adjustments, for each line item in |
| | | minute detail. |
| | | Date/Time/User stamp on all |
| | | transactions |
| | Patient Payment | Default display shows all Receipts |
| | | with amounts that can be allocated, |
| | | and all open items that can have |
| | | payments applied. |
| | | Choose payment and apply to one |
| | | item or several items in one |
| | | transaction. |
| | | Oldest items show first in display, |
| | | viewed with service date, procedure |
| | | code and original charges with |
| | | summary history of item. |
| | Payer Payment | Post single and multiple remittance |
| | | in one screen. |
| | | Post to multiple Patient Accounts in |
| | | one transaction without having to |
| | | look them up. |
| | | Choose from list of Payers with |
| | | receipt credits to be allocated |
| | | Apply full and partial payments |
| | | Compare actual payment with |
| | | expected payment |
| | | Display shows service date, |
| | | procedure code, original charge, |
| | | current balance, expected payment, |
| | | and summary of previous |
| | | transactions. |
| | Managed Care | Line Item Managed Care |
| | Adjustments | Adjustments can be posted in the |
| | | same transaction as the payment so |
| | | multi-patient EOB posting with |
| | | discounts and adjustments from the |
| | | Managed Care Plan are simple and |
| | | fast! |
| | Payment Code | Using Payment Codes can activate |
| | Processing | different functionality for payment |
| | | processing, such as setting billing |
| | | indicators, tagging for rebilling, |
| | | overpayments, etc. |
| | | Denials of payment from insurance |
| | | can be tagged for resubmission or |
| | | sending to another Payer or to the |
| | | Patient. |
| | | Over payments where the rate |
| | | negotiated is more than the fee or |
| | | charges can be posted and tracked. |
| | Reverse Payments | Process Returned Checks and Failed |
| | | Credit Card Transactions |
| | | Reverses allocations made from |
| | | Returned Checks and Opens line |
| | | items that were closed by that Check |
| | | Allocation |
| | | Add a Returned Check Charge when |
| | | required. Goes on the Patients |
| | | account and Statement. |
| | Adjustments | 22 standard EON Adjustments |
| | | Track Managed Care Adjustments, |
| | | including discounts, contractual |
| | | overpayments, flat rate pays. |
| | | Track bad-debt write off, small |
| | | balance write-off. |
| | | Correct Errors in Posting from Payer, |
| | | Items are tracked for account |
| | | production reports |
| | | Correct misapplied payments from |
| | | Patients |
| | | Reverse any adjustment, actually |
| | | acts as an “Undo” no matter when it |
| | | happened. Even if the account was |
| | | satisfied, it will reopen the items. |
| | | Easily add new adjustment codes to |
| | | track your needs. |
| | Reverse | Reverse any adjustment you may |
| | Adjustments | have made, even on Satisfied items. |
| | Refund Processing | Process refunds to Patients Payers |
| | and | and Customers, connected directly to |
| | Tracking/History | the original receipt. |
| | Refund Request | View all Requests for Refund in |
| | | Patient Central View |
| | | Create a Refund Request Record, for |
| | | processing, on any receipt or credit |
| | | in the system. |
| | | Tag with a Reason for Refund, and |
| | | comments. |
| | Refund Approval | Choose any previously created |
| | | Request and Approve Full Refund |
| | | with Check or Payment # issued and |
| | | amount. |
| | | Deny any refund |
| | | Approve only Partial amount of |
| | | refund requested. |
| | | Void Refund if incorrect so you can |
| | | process a new request. |
| | Monthly Close Out | For each Month, choose a Pay-to |
| | | Provider and process all |
| | | transactions. |
| | | Runs in a background process, with |
| | | the Job Monitor. |
| | | Creates a Close by Facility or one |
| | | each for all Facilities. |
| | | View on-line each summary set by |
| | | Facility. |
| | | Creates summary records by |
| | | Provider also. |
| | | Runs all Revenue by Service Date |
| | | Runs all Receipts posted by Batch |
| | | Date, so you can use the Receipt |
| | | Batch Retro date to post late. This |
| | | lets the user go on with the next |
| | | months entries before finalizing last |
| | | month with no problems. |
| | | Runs all Adjustments, Reversals, and |
| | | Refunds by Transaction Date. |
| | Payer Collections | Search for Claims, by Payer, for |
| | | access to details. |
| | | User can define time parameters in |
| | | days for range, such as over 30 days |
| | | since bill date, over 60 days since bill |
| | | date, etc. Allows you work thru the |
| | | aged balances. |
| | Follow-up | For each Payer Accessed, Addresses |
| | Documentation | and Phone #s are displayed for |
| | | contacting the Payer. |
| | | Claims details like Claim #, Service |
| | | Date, Batch #, for reference. |
| | | User/Date/Time stamped Notes on |
| | | each claim. |
| | | Notes can have a re-call or follow-up |
| | | date attached, so the user can be |
| | | reminded. |
| | | Can record as many notes per claim |
| | | as needed. |
| | | Once notes are recorded, they |
| | | cannot be altered, you can make new |
| | | ones. Legally, this is important for |
| | | collection action. |
| | Budget Payment | Specially for patients who need help |
| | Plans | making payments and will get |
| | | regular A/R Statements. |
| | | Budget Plans can be set up for |
| | | Monthly amounts, that show up on |
| | | the Statement, with regular balances |
| | | and aging. |
| | | Additional Services can continue to |
| | | be added to this account. |
| | Critical Accounts | User defined parameters of aging |
| | On-line Search | dates or dollar amounts can used to |
| | | get on line view of Patient Accounts |
| | | where the Patient balance is |
| | | overdue, or overly large. Great for |
| | | Up to the minute balances. |
| | | In-House Process where accounts |
| | | are Marked for Collections, and |
| | | Account Status is Updated. Notes can |
| | | be recorded, with next contact dates |
| | | to create a list of people each day for |
| | | collector to follow up. |
| | | Search for Account by User defined |
| | | date ranges of aging from Date of |
| | | First bill to Patient. |
| | | Process full balance to new |
| | | collections Account #. |
| | | Assign Collector to Account |
| | | Notes for calls to patient or |
| | | Guarantor are User/Date/Time |
| | | Stamped, and cannot be altered after |
| | | making. |
| Contract | System Wide | Enter Contracts by Name and ID, |
| Management | Functionality in all | then associate with all or specific |
| | Billing Processes | Providers and load Contract Rates |
| | | for billing, by HCFA, UB and |
| | | Provider List Bill functions. This |
| | | includes Medicare, Medicaid and |
| | | any negotiated contract for your |
| | | business. |
| | Calculating | Load Pay-rates for contracts for |
| | Expected | any flat fees to be used in |
| | Payments by | Expected Payment calculations to |
| | Contract Rates in | evaluate payments and |
| | Encounters | comparisons for accuracy. |
| | | Expected amounts are shown on |
| | | the Payer Payment functions for |
| | | On-line Comparisons and in |
| | | Reports for Expected Payment |
| | | Projections. |
| | Contract Summary | Enter a Contract Summary for the |
| | | defaults of any given contract, by |
| | | ID. |
| | | Create Summaries of Contract |
| | | defaults and parameters. |
| | | Contract ID and description |
| | | Product ID and description |
| | | Network ID and description |
| | | Coverage ID and description |
| | | Discount percentage |
| | | Control by user-defined entries of |
| | | Contract Ids, Product Ids and |
| | | Coverage ID's. |
| | | Build and Review Contract |
| | | Summary with Rates, Discounts, |
| | | Risk Sharing and Contract |
| | | Maximum |
| | | Enter and Track Met Amounts at a |
| | | Glance |
| | | Repriced Amount Met Amounts |
| | | Bonus Incentive Met Amounts |
| | | Fund Pool Met Amounts |
| | Contract Service | Enter Service Categories, and |
| | Details | define limits, referral and auth |
| | | requirements and any other |
| | | decision levels |
| | Indexes | Build new function for |
| | | processing by: Contract, Product, |
| | | Network, Coverage, Type of |
| | | Provider, Benefit, Type of Service, |
| | | Service, Place of Service, |
| | | Diagnosis, and Procedure with the |
| | | Expert without programming |
| | | Define any database element as |
| | | an index. |
| | Build Contract | The ability to design workflow |
| | Workflows | objects, in scripts, and the order |
| | | of the objects to be executed |
| | | during a process. |
| | | The ability to maintain and alter |
| | | the current processing flows, for |
| | | customizing processes to your |
| | | business, without compiling a |
| | | program. |
| | | EON SYSTEM Report Features |
| Reports | Report List | The Report List has a Search |
| | | capability that allows a |
| | | search on Title or |
| | | Description, or scroll thru |
| | | list for all operating reports |
| | | and queries. |
| | | List has detailed descriptions |
| | | for the user. |
| | Run System Reports | Just click on Report Name to |
| | | execute |
| | | All Reports are run in a |
| | | background processing |
| | | mode, with an on-line |
| | | monitor to tell you when it's |
| | | done. |
| | Reports Monitor | After Requesting a Report, |
| | | you can go back to using the |
| | | other functions in the |
| | | system, while waiting on |
| | | your requests to complete, |
| | | allowing for better |
| | | production. |
| | | The Report Monitor shows all |
| | | the Reports you have |
| | | requested and monitors |
| | | when you initiated them, |
| | | and when they completed. |
| | | Report Results are stored in |
| | | the database. You can |
| | | always go back and access |
| | | them again, no worries over |
| | | losing track of printed items. |
| | Enter Parameters for | Each Report has parameters |
| | Sorts and Ranges | for sorting, if none are |
| | | entered the report runs all |
| | | data. |
| | | For the Parameters, Find It's |
| | | are provided for easy |
| | | application of parameters. |
| | Choose Report Formats | Reports can be run in either |
| | | HTML or PDF formats. |
| | | Most reports can be run in |
| | | HTML format, which allows |
| | | portrait or landscape views |
| | | and lots of color for easier to |
| | | read reports in seconds. |
| | View On-line | HTML reports can be scrolled |
| | | thru in their entirety, so you |
| | | can use them on-line |
| | | without printing for |
| | | research. |
| | Print | Use the Browser print |
| | | commands or just right-click |
| | | on the report and choose |
| | | “print”. |
| | | Download, all PDFs can be |
| | | clicked on to download to |
| | | where you need them, or |
| | | opened right away, for |
| | | printing, without |
| | | downloading. |
| | Save and Store | All Reports can be |
| | | transported to PDF (read- |
| | | only, specifically formatted |
| | | files) that can be saved to |
| | | your hard drive or network |
| | | drives. They are |
| | | automatically stored in the |
| | | EON database. |
| | Distribute | PDFs are great for |
| | | distribution to report |
| | | recipients. Client uses free |
| | | Adobe Acrobat reader for |
| | | managing PDFs. |
| | Reports Admin | List of all Reports possible |
| | | for menu, enable or turn off. |
| | | Change the Title of the |
| | | Reports to suit your business |
| | | Ability for user to Customize |
| | | headers and Footers for |
| | | certain reports or Outputs |
| | | for Practice or Clinic names |
| | | or even logos! Just change |
| | | the content parameters |
| | | before running the report. |
| | | Non-formatted queries can |
| | | be used to copy-paste data |
| | | into excel or access. |
| | | Assign Newly designed or |
| | | modified forms for specially |
| | | formatted and aligned |
| | | printouts. |
| | Reports Forms | Ability to assign specific |
| | | printing properties to any |
| | | report, and align each piece |
| | | of data if necessary. Assists |
| | | in printer alignment when |
| | | changing printers for form |
| | | printing such as HCFA or |
| | | UB92. |
| | Adjustments Listing | All Adjustments, by Type, |
| | | and Date, Patient Account |
| | | affected, amount adjusted. |
| | | Parameters for executing |
| | | report: From and Thru Date |
| | | user-defined, run for today |
| | | or an date range. |
| | Admissions Listing | By Facility, lists all Current |
| | | Admissions for Date Ranges |
| | | entered by User, or if none |
| | | entered, all Current |
| | | Admissions. Includes Patient |
| | | Name, and demographics, |
| | | with Room #s. |
| | | Parameters are Facility, |
| | | From Date and Thru Date. |
| | Appointment History by | By Patient see all |
| | Patient | appointments, No-Shows, |
| | | Cancellations, etc. |
| | | Parameters for executing |
| | | report: For a selected |
| | | patient, from and thru dates |
| | | are user-defined, run for |
| | | today or any date range |
| | Appointment Recall | Appointments that had recall |
| | Listing | dates, but the Patient hasn't |
| | | shown up for the |
| | | appointment. For follow-up. |
| | | Parameters for executing |
| | | report: From and thru date |
| | | user-defined, run for today |
| | | or any date range. |
| | Appointment Waiting | Reports on those patients |
| | List | who are on a waiting list for |
| | | a given facility and provider. |
| | | Parameters for executing |
| | | report: Date, Patient, Type |
| | | of appointment, Facility and |
| | | Provider preference. |
| | Appointments | All appointments where the |
| | Completed with Missing | event has been completed, |
| | Charges | but as yet no charges were |
| | | entered. |
| | | Parameters for executing |
| | | report: Facility and from |
| | | and thru dates. |
| | Appointments Schedule | Acts as daily list or “pull” |
| | | sheet for appointments. List |
| | | patient's appointments by |
| | | time slot for a given provider |
| | | and facility. Also list |
| | | patient's phone number and |
| | | the scheduled event. |
| | | Parameters for executing |
| | | report: Facility, provider |
| | | and from and thru dates. |
| | Appointments Passed | Appointments that were |
| | without Completion | made and were not updated |
| | | to a completed status. To |
| | | help complete scheduling |
| | | tracking. |
| | | Parameters for executing |
| | | report: Facility, provider |
| | | and from and thru dates. |
| | Appointments Schedule | For the Provider to use, |
| | with Complaints | daily, show the |
| | | Appointments by Physician, |
| | | indexed by Time, listed with |
| | | the complaint or symptoms |
| | | the patient has, which is the |
| | | reason for the appointment. |
| | | Parameters for executing |
| | | report: From and thru dates. |
| | Appointments | Report displays only |
| | Scheduled without | appointments incorrectly |
| | Events | entered without a scheduled |
| | | event. |
| | Appointments by Payer, | List appointments by payer |
| | Plan | for facility and provider. The |
| | | list also identifies the plan |
| | | for each patient. Allows |
| | | provider to compare mix of |
| | | patients that he or she is |
| | | seeing by payer and plan. |
| | | Parameters for executing |
| | | report: Facility and from |
| | | and thru date. |
| | Appointments with | Pull List for Schedules with |
| | Medical Record # (Chart | Chart #s for all Scheduled |
| | #) | Patients. Indexed by Patient |
| | | Name. |
| | | Parameters are From and |
| | | Thru Dates. |
| | Appointments, No-Show | Identifies those patients |
| | | who had a scheduled |
| | | appointment but did not |
| | | show up for the |
| | | appointment. Can be used |
| | | for re-calls to patients. The |
| | | report list the appointments |
| | | by facility and provider. |
| | | Parameters for executing |
| | | report: From and Thru |
| | | dates. |
| | Billing: Claims Register | Lists all HCFA's billed in an |
| | by Electronic File Name | electronic batch file. |
| | | Indexed by file name, payer |
| | | name, and billed date. |
| | | Includes patient name, claim |
| | | ID, diagnosis, procedure and |
| | | charges. |
| | | Parameters for executing |
| | | report: Electronic File name |
| | | and from and thru dates. |
| | Charges Reconciliation | Listing of charges by |
| | Report | rendering physician. |
| | | Includes service date, use |
| | | date of last modification, |
| | | patient, and info on |
| | | individual service lines. |
| | | parameters for executing |
| | | report: From and thru dates. |
| | Clearing House | Report used to implement or |
| | Parameter File Listing | update parameters for any |
| | | clearing house the system |
| | | will send claim files to. |
| | | Prints out a list of |
| | | specifications for field |
| | | names and positions that |
| | | occur in the electronic file |
| | | creation and can easily be |
| | | compared to the specs |
| | | provided by the clearing |
| | | houses, to help in |
| | | implementing new file |
| | | formats or changes made |
| | | periodically by the clearing |
| | | houses. |
| | | Parameter is File ID. |
| | Collection Notes by | Lists all Accounts where the |
| | Patient | collectors have made notes |
| | | for collections in the |
| | | Accounting/Collections |
| | | functions, indexed by |
| | | Patient. |
| | Collection Notes by | Indexed by Payer, lists all |
| | Payer | notes by on claims follow-up |
| | | by collectors to Payer, for |
| | | claims status resubmissions |
| | | etc. |
| | | Parameters are Payer Name |
| | | and From and Thru Dates. |
| | Collection Notes by user | Indexed by User all notes |
| | | made in the Collection area, |
| | | includes all text and names |
| | | and accounts with claim #s. |
| | | Great Production Report to |
| | | monitor collector work |
| | | Parameter are User, From |
| | | and Thru Dates. |
| | Collections: Payment | List all Patient with Budget |
| | Plan Set-Up (Not | Plants for their accounts. |
| | formatted) | |
| | Daily Close-Out Listing | List of all Daily Close Outs, |
| | | with Batch ID, Totals, |
| | | facility. |
| | | Parameters for executing |
| | | report: From and thru dates |
| | | so you can pull Daily or |
| | | Monthly, for receipt |
| | | checking. |
| | Daily Close-Out Report | Single Receipt Batch defined |
| | | with all details. |
| | | Parameters for executing |
| | | report: Facility, site owner, |
| | | and from and thru dates. |
| | Detailed Account | All transaction for a given |
| | Activity (Not Formatted- | account, are listed. |
| | Table View) | |
| | | Parameters for executing |
| | | report: User defined Date |
| | | Range, multiple accounts |
| | | can be listed, so all daily |
| | | transactions are displayed |
| | | here by Patient. |
| | Detailed Aging Report: | Aging Report for Patient |
| | By Patient Account | Accounts where the service |
| | | Items have actually been |
| | | billed to the Patient, as |
| | | Patient Responsibility. |
| | | Run for all Dates, reporting |
| | | shows: current to 30, 31-60 |
| | | 61-90, 91-120 121+ |
| | Detailed Aging Report: | Aging Report shows all items |
| | By Payer | that have been billed to |
| | | Payers, and are awaiting |
| | | payment, aged from billed to |
| | | Payer Date. |
| | | Run for all Dates, reporting |
| | | shows: current to 30, 31-60 |
| | | 61-90, 91-120, 121+, |
| | | detail for each line item, |
| | | with reference to Patient, |
| | | code, and Account# |
| | Diagnostic Orders | Order from per test for any |
| | | ordered diagnostic test |
| | | recorded in that application. |
| | | Patient info included. |
| | | Suitable for any outside lab |
| | | orders. Parameter is Test |
| | | Event (encounter) |
| | Diagnostic Test Results | Results of Diagnostic Tests, |
| | | including discreet results for |
| | | panels. Parameter is Test |
| | | Event (encounter) |
| | Diagnostic Results by | List of test results for |
| | Physician | multiple Patients for an |
| | | entered Physician. Great for |
| | | reviewing all new test |
| | | results by date. |
| | | Parameters: Ordering |
| | | Provider, From and Thru |
| | | Dates. |
| | Disability Report | All information in the |
| | | Disability Record in the |
| | | Medical Records, including |
| | | Case #, Patient |
| | | demographics, and details of. |
| | | disability as entered by |
| | | Provider. |
| | | Parameters are Patient |
| | | name and Dates of Injury. |
| | Disability: Doctors | A standard “excuse note” for |
| | Excuse (Not Formatted- | patients who have injuries |
| | Table View) | prohibiting them from |
| | | working. The excuse |
| | | includes the dates that the |
| | | patient is unable to work |
| | | and what restrictions apply |
| | | once the patient returns to |
| | | work. |
| | | Parameters for executing |
| | | report: Patient name. |
| | Encounter Forms | Print to a pre-printed form, |
| | | data available: Patient |
| | | Name, Insurance, Service |
| | | Event, date, Balance of |
| | | Account, Physician, and |
| | | location. |
| | | Parameters for executing |
| | | report: User-defined Date |
| | | Range, print all encounter |
| | | forms for tomorrow's work, |
| | | or print specific page(s), |
| | | from PDF. Reprint when |
| | | necessary. |
| | Encounter Forms Single | Print by Patent Name, Date, |
| | (Not Formatted-Table | great for walk-ins. |
| | View) | |
| | | Parameters for executing |
| | | report: Scheduled event ID. |
| | Encounters Not Billed | List all Encounters not billed |
| | | out, where charges have |
| | | been entered. |
| | Expected Payments (Not | Listing of all encounters |
| | Formatted-Table View) | processed against a plan |
| | | including provider, patient, |
| | | date, procedure, diagnosis, |
| | | charge, and expected |
| | | payment. The patient's |
| | | deductible met is also |
| | | provided for reference in the |
| | | event an expected payment |
| | | is zero. Sorted by event. |
| | Facility Listing | Lists all facilities with a |
| | | profile Including complete |
| | | address, phone numbers, |
| | | and facility type description. |
| | HCFA PRINT | Prints all HCFA's for a user- |
| | | defined date range. Used for |
| | | billing those payers who |
| | | require hard-copy claims to |
| | | be submitted. |
| | | Parameters for executing |
| | | report: From and thru date |
| | | ranges. |
| | HIPAA Tracking Report | Compliance with HIPAA in an |
| | | easy list print. Shows every |
| | | transaction made on the |
| | | dates entered by user. |
| | | Shows User, Date Time of |
| | | Transaction, and Type of |
| | | Transaction. Includes log on |
| | | and off in system, and failed |
| | | attempts at log on. |
| | | Parameters are From and |
| | | Thru Dates. |
| | HIPAA Tracking Report | Each screen in the system |
| | by Tracking Type | has a Tracking Type name. |
| | | User can get a list of Log- |
| | | Ons only if required. Or |
| | | Medical Record entries. |
| | HIPAA Tracking Report | Pick a User and get all |
| | by User Name | transactions for any given |
| | | date(s). Great production |
| | | and security monitoring |
| | | report. |
| | | Parameters are user name |
| | | and From and Thru Dates. |
| | Insurance Claims Report | Listed by carrier name. |
| | (Not Formatted-Table | Shows each patient, service |
| | View) | date, encounter #, and |
| | | status. Encounters must |
| | | have one of the following |
| | | statuses to display in this |
| | | report: Billed, Pre- |
| | | collections, Collections, |
| | | Patient Responsibility, |
| | | Reviewed. Identifies the |
| | | procedure code, billed |
| | | amount and the balance per |
| | | encounter, per payer, and |
| | | grand totals for all payers. |
| | | Parameters for executing |
| | | report: From and thru date |
| | | range. |
| | Insurance | An analysis of |
| | Reimbursement Analysis | reimbursements per-insurer, |
| | Report (Not Formatted- | per procedure. Listing |
| | Table View) | procedure and diagnosis |
| | | codes with the |
| | | corresponding charges, paid |
| | | amounts, and |
| | | reimbursement percentages. |
| | | Parameters for executing |
| | | report: User may define |
| | | reporting period by claim |
| | | date/encounter date. |
| | Job Messages Report | Any Job that has been run in |
| | | the system can be accessed |
| | | and all messages, whether |
| | | errors or not, can be printed |
| | | out. |
| | | Job ID parameter. |
| | Listing of Encounters in | Listing of all encounters |
| | Pre-Collections (Not | within a specified time |
| | Formatted-Table View) | period with the status of |
| | | “K”, including patient name, |
| | | encounter ID, encounter |
| | | date, total balance due. |
| | | Parameters for executing |
| | | report: User may define |
| | | date range. |
| | Mammogram Reminder | Allows user to print a |
| | Letter (Not Formatted- | reminder letter for annual |
| | Table View) | mammograms for female |
| | | patients age 50 and older. |
| | Mammogram Reminder: | To be printed in conjunction |
| | Mailing Labels (Not | with the “Mammogram |
| | Formatted-Table View) | Reminder Letter” on labels |
| | | 1″ × 2.62″. |
| | Medical Information | This is a standard form |
| | Release Authorization | allowing a patient to |
| | Form (Not Formatted- | authorize your office to |
| | Table View) | release medical information |
| | | to insurance companies in |
| | | order to receive |
| | | compensation. The form |
| | | prints with the practice's |
| | | name, address, phone and |
| | | fax numbers. |
| | | Parameters for executing |
| | | report: User may define the |
| | | practice for which the report |
| | | should be run. |
| | Medical Records | This is a standard form |
| | Request Form (Not | requesting a patient's |
| | Formatted-Table View) | medical records from |
| | | another provider's office. |
| | | The form prints with the |
| | | practice's name, address, |
| | | phone and fax numbers. |
| | | Parameters for executing |
| | | report: User may define the |
| | | practice for which the report |
| | | should be run |
| | Medical Records | This is a standard form |
| | Transfer Form (Not | allowing a patient to request |
| | Formatted-Table View) | that your office transfer |
| | | his/her medical records to |
| | | another provider's office. |
| | | The form prints with your |
| | | practice's |
| | | Parameters for executing |
| | | report: User may define the |
| | | practice for which the report |
| | | should be run |
| | Monthly Financial | This report is a by-product of |
| | Summary | running the Monthly Close. |
| | | It identifies for a given |
| | | practice information such as |
| | | charges, revenue, receipts, |
| | | total visits, etc. for each |
| | | physician within the |
| | | practice. |
| | | Parameters for executing |
| | | report: User may define the |
| | | date ranges for printing the |
| | | report. |
| | Order Tests | Sorted by event, provides |
| | | facility information, provider |
| | | name and phone, patient |
| | | name, requisition number, |
| | | collection date, diagnosis |
| | | procedure, specimen #, |
| | | specimen type, report date, |
| | | diagnosis normals, results |
| | | and diagnosis status. |
| | | Parameters for executing |
| | | report: User may define the |
| | | from and thru dates. |
| | Orders Listing by | All Orders for a given |
| | Patient Admission | admission, with statuses and |
| | | notes. |
| | | Parameters are Patient |
| | | Name, Facility, Admission |
| | | From and Thru Dates. |
| | Patient Bill | On demand bill for one |
| | | encounter on one service |
| | | date, including patient |
| | | receipt information. |
| | | Parameters for executing |
| | | report: Event ID. |
| | Patient Listing 1 | Lists patients with address, |
| | | city, state and zip |
| | Patient Listing 1: By Zip | Lists all patients with |
| | Code (Not Formatted- | address, city, state and zip. |
| | Table View) | |
| | | Parameters for executing |
| | | report: Users may define |
| | | the zip code to be used for |
| | | generating the report. |
| | Patient Listing 2 (Not | Lists patients with address, |
| | Formatted-Table View) | city, state, ZIP and phone |
| | | numbers. |
| | Patient Listing 2: By | Lists all patients within a |
| | State (Not Formatted- | user-defined state, with |
| | Table View) | address, city, zip, home |
| | | phone and work phone |
| | | numbers. |
| | | Parameters for executing |
| | | report: Users may define |
| | | the state to be used for |
| | | generating the report. |
| | Patient Listing 3 (Not | Lists all patients with |
| | Formatted-Table View) | address, city, state, zip, and |
| | | date of birth. |
| | Patient Listing 3: | Lists all patients with a |
| | Birthday List (Not | defined month of birth with |
| | Formatted-Table View) | address, city, state, zip, |
| | | month, and date of birth. |
| | | Parameters for executing |
| | | report: Month |
| | Patient Listing 4 (Not | Lists all patients with |
| | Formatted-Table View) | address, city, state, zip, age |
| | | and sex. |
| | Patient Listing 4: By | Lists all patients within a |
| | Age and Sex (Not | define age group and gender |
| | Formatted-Table View) | with address, city, state, zip, |
| | | age and sex. |
| | Patient Listing 5: Last | Lists patients with address, |
| | Visit (Not Formatted- | city, state, zip, and date of |
| | Table View) | last visit. |
| | | Parameters for executing |
| | | report: User may define |
| | | reporting period using |
| | | encounter date range. |
| | Patient Listing 6: | Lists patients with |
| | Emergency Contacts | emergency contacts' name, |
| | | relationship, home and work |
| | | phone numbers. |
| | Patient Listing 7: New | Indexed by patient name. |
| | Patients (Not | Lists new patients with |
| | Formatted-Table View) | address, city, state, zip, |
| | | effective date. Also provides |
| | | insurance coverage |
| | | information such as payer, |
| | | plan, and product. |
| | | Parameters for executing |
| | | report: user may define date |
| | | parameter. |
| | Patient Listing by | Pick a Payer and get a list of |
| | Primary Payer | all Patient whose Primary |
| | | Coverage is under chosen |
| | | Payer. Good List for |
| | | Members of Plans you |
| | | support. |
| | Patient Receipt | Lists by facility along with |
| | | facility's phone number, |
| | | receipts to give to patients |
| | | for payments they have |
| | | made. The report lists the |
| | | payee, the date of receipt, |
| | | the account number, the |
| | | receipt amount and the form |
| | | of payment. |
| | | Parameters for executing |
| | | report: Users may define the |
| | | Receipt ID that they want to |
| | | print. |
| | Patient Registration | Indexed by patient. |
| | | Provides the following |
| | | information: patient name, |
| | | SSN, driver's license, |
| | | primary provider name, |
| | | address, phone numbers, |
| | | DOB, sex marital status, |
| | | race, # of children, student |
| | | status, emergency contact |
| | | information, employment |
| | | information and insurance |
| | | information. |
| | Patient Statement | Indexed by responsible |
| | | party. Provides responsible |
| | | party name, address, |
| | | statement date, due date, |
| | | pay amount, and pay to |
| | | name and address. Includes |
| | | doctor seen, dates of |
| | | service, service code and |
| | | description, amount billed to |
| | | insurance, paid by |
| | | insurance, adjustments, |
| | | paid, and patient balance. |
| | | Lists overall current balance, |
| | | over 30 days, over 60 days, |
| | | over 90 days, over 120 days, |
| | | and total balance. |
| | | Parameters for executing |
| | | report: Users may define |
| | | reporting date period. |
| | Patient Statement Form | Patient statement formatted |
| | | for PDF download, for batch |
| | | print. |
| | | Parameters for executing |
| | | report: Users may define |
| | | date range |
| | Payer Contract | List of Contractual |
| | OverPayments | OverPayments, the ones that |
| | | are agreed to, and do not get |
| | | refunded. |
| | Payer Listing | Lists each payer with a |
| | | profile, including complete |
| | | address, phone numbers, |
| | | whether or not the payer |
| | | receives electronic bills, and |
| | | the name of the payer's |
| | | clearing house. |
| | Payer Plan Summary | Summarizes the options |
| | | provided by a given plan, |
| | | including plan name and id, |
| | | product name and id, |
| | | coverage name and id, |
| | | effective and termination |
| | | dates, and limits for |
| | | deductibles, out-of-pocket, |
| | | lifetime maximum, |
| | | coinsurance percentages, |
| | | and service limits. |
| | Payer Mix Analysis (not | Indexed by insurer. Total |
| | formatted, table view) | number of claims, total billed |
| | | amounts, total paid |
| | | amounts, and total |
| | | reimbursement percentages |
| | | for each carrier printed on a |
| | | separate page. |
| | | Parameters for executing |
| | | report: Users may define |
| | | the dates for reporting. |
| | Personnel Schedule | Indexed by facility, |
| | | department, and personnel. |
| | | Includes scheduled dates, |
| | | scheduled times, floor, unit, |
| | | room, resource type, |
| | | scheduled by, and type of |
| | | service scheduled. |
| | | Parameters for executing |
| | | report: Users may define |
| | | facility name, personnel first |
| | | and last name, and reporting |
| | | period. |
| | Personnel Schedule for | Lists all personnel scheduled |
| | Facility | on a given day for a given |
| | | facility. Includes scheduled |
| | | dates, scheduled times, |
| | | floor, unit, room, resource |
| | | type, scheduled by, and type |
| | | of service scheduled. |
| | | Parameters for executing |
| | | report: Users may define |
| | | facility name and from and |
| | | thru dates. |
| | Physician Financial | Account Information for each |
| | Summary | physician within the practice |
| | | appears on an individual |
| | | page. Includes number of |
| | | patients seen, total charges, |
| | | total receipts, total |
| | | adjustments, total |
| | | receivables, and percentage |
| | | of charges collected. |
| | | Parameters for executing |
| | | report: User may define |
| | | reporting period using claim |
| | | dates. |
| | Practice Financial | Indexed by practice. For |
| | Summary | each physician in the |
| | | system, provides a detailed |
| | | breakdown of production, |
| | | billed amounts, adjustments, |
| | | and receivables, in addition |
| | | to collections, and provides |
| | | grand totals for the practice. |
| | | Parameters for executing |
| | | report: User may define |
| | | practice name and reporting |
| | | period using claim dates. |
| | Prostate Exam Reminder | Allows user to print a |
| | Letter (Not Formatted- | reminder letter for annual |
| | Table View) | prostate exams for male |
| | | patients age 45 and older. |
| | Prostate Exam | To be printed in conjunction |
| | Reminder: Mailing | with the “Prostate Exam |
| | Labels (Not Formatted- | Reminder Letter” on labels |
| | Table View) | 1” × 2.62”. |
| | Provider Credentialing: | Printed by provider, includes |
| | Contracts (Not | name, address, phone |
| | Formatted-Table View) | numbers, provider ID, ID |
| | | type, SSN, DOB, sex, |
| | | citizenship status, languages |
| | | spoken, provider type, |
| | | speclalty, effective and |
| | | termination dates. |
| | | Parameters for executing |
| | | report: User may define |
| | | provider's name. |
| | Provider List Bill | produced by processing a |
| | | provider list bill under |
| | | Billing. Indexed by payer. |
| | | Provides PayTo name and |
| | | address, payer name, billing |
| | | period, bill number. Lists |
| | | patient name, SSN, group |
| | | ID, service date, diagnosis, |
| | | procedure, charges, and |
| | | rendering physician. |
| | | Parameters for executing |
| | | report: User may define |
| | | payer's name and date |
| | | range. |
| | Provider Listing | Lists physicians with nme, |
| | | ID, complete address, and |
| | | phone number. |
| | Provider Listing with | Indexed by provider. |
| | service Facilities | Includes name, address, |
| | | phone DOB, sex, and all |
| | | facilities connected to the |
| | | provider with their |
| | | respective addresses, |
| | | effective and termination |
| | | dates. |
| | Provider Productivity by | Indexed by physician. Lists |
| | Procedure (Not | procedure and diagnosis |
| | Formatted-Table View) | codes with corresponding |
| | | total charges, insurer paid, |
| | | and reimbursement |
| | | percentages. Also includes |
| | | times each procedure has |
| | | been performed by each |
| | | provider and an average |
| | | charge. Includes number of |
| | | different procedures and |
| | | total percentage of |
| | | reimbursements. |
| | | Parameters for executing |
| | | report: User may define |
| | | reporting period using |
| | | encounter date. |
| | Provider Referrals | Sorted by rceiving provider. |
| | | Lists patient information, |
| | | referring provider, reason |
| | | for referral, referral date, |
| | | diagnosis, procedure, and |
| | | authorization. |
| | Provider Referrals 2 | Listing of referrals Indexed |
| | | by referring provider and |
| | | payer. Includes date, |
| | | patient authorization code, |
| | | and reason for referral. |
| | | Parameters for executing |
| | | report: User may define |
| | | from and thru date range. |
| | Receipts Analysis Report | Breaks down all receipts by |
| | | payment type, providing |
| | | payer name, payment |
| | | method, and date posted. |
| | | Shows subtotals for each |
| | | method and an overall total |
| | | of receipts. |
| | | Parameters for executing |
| | | report: User defines |
| | | reporting period by remit |
| | | date. |
| | Receipts Analysis | Variation of “receipts |
| | Report: By Payment | Analysis” that allows user to |
| | Type (Not Formatted- | specify a payment type: |
| | Table View) | cash, personal check, |
| | | insurance check, VISA, |
| | | Master Card, AMEX, or other. |
| | | Only the receipts of the |
| | | chose payment type appear. |
| | | Parameters for executing |
| | | report: User may define |
| | | reporting period by remit |
| | | date. |
| | Receipts Summary | Summary of receipts by |
| | | facility, including receipt |
| | | amount, amount available, |
| | | and amount allocated. |
| | | Parameters for executing |
| | | report: User may define |
| | | date range and Facility |
| | | name. |
| | Receipts: Unallocated | Listing of all patient receipts |
| | Credits by Patient | based on a user-defined |
| | | patient that have not been |
| | | fully allocated. Includes |
| | | patient name, ID, current |
| | | account balance, receipt |
| | | date, receipt amount, |
| | | amount type, original receipt |
| | | amount, and current |
| | | unallocated amount. |
| | | Parameters for executing |
| | | report: Users my define the |
| | | patient name. |
| | Receipts: Unallocated | Listing of all payer receipts |
| | Credits by Payer | for a user-defined payer, |
| | | that have not been fully |
| | | allocated. Includes payer |
| | | name, payer alternate ID, |
| | | receipt date, receipt amount, |
| | | amount type, original receipt |
| | | amount, and current |
| | | unallocated amount. |
| | | Parameters for executing |
| | | report: User may define the |
| | | payer name. |
| | Receivables Aging | Listing of all encounters with |
| | Report (Not Formatted- | status of Patient |
| | Table View) | Responsibility and Billed to |
| | | Insurance sorted into 0-30 |
| | | days, 31-60 days, and 61-90 |
| | | days. And over 90 days. |
| | | Includes encounter date, |
| | | encounter ID, status, and |
| | | balance due. Also has grand |
| | | totals for each of three |
| | | categories. |
| | Receivables Summary | Summary of all encounter |
| | by Encounter Status | service charges by facility |
| | | and encounter status. |
| | | Includes remaining balance. |
| | | Parameters for executing |
| | | report: User defined date |
| | | ranges. |
| | Refund Requests: | IndeXed by payee. Provides |
| | Patient | payee name, account |
| | | number, and account |
| | | balance. Lists request date, |
| | | request amount, refund |
| | | type, and refund reason. |
| | | Parameters for execuling |
| | | report: User defined date |
| | | range. |
| | Refund Requests:Payer | Indexed by payer. Provides |
| | | payer name and payer ID. |
| | | Lists request date, request |
| | | amount, refund type; and |
| | | refund reason. |
| | | Parameters for executing |
| | | report: user may define |
| | | from and thru dates. |
| | Reprint Prescriptions | Prints out prescriptions |
| | (Not Formatted-Table | written on dates in a user- |
| | View) | defined range for patients |
| | | defined by the user. |
| | | Includes physician name, |
| | | patient name, and address. |
| | | Lists drug description, route, |
| | | dose, units, frequency, |
| | | quantity, refills and |
| | | physician notes. |
| | | Parameters for executing |
| | | report: User may define |
| | | patient name and from and |
| | | thru dates. |
| | SOAP Notes | Prints all SOAP notes for a |
| | | user-defined patient and |
| | | date range. Sorted by event |
| | | ID, patient name and SOAP |
| | | type. |
| | | Paramters for executing |
| | | report: User may define |
| | | patient name and from and |
| | | thru dates. |
| | Summary Aging Report: | Sorted by patient account. |
| | By Patient Account | Lists all balances due divided |
| | | into “current” (0-30 days), |
| | | 31-60 days, 61-90 days, and |
| | | over 90 days along with |
| | | patient name, phone number |
| | | and total balance. |
| | Summary Aging Report: | Sorted by payer name. Lists |
| | By Payer | all balances due divided into |
| | | “current” (0-30 days), 31-60 |
| | | days, and over 90 days along |
| | | with payer name, and total |
| | | balance. |
| | Total Charges Summary | Sorted by facility name. |
| | By Encounter Status | Lists totals for charges and |
| | | balance remaining for each |
| | | encounter status. |
| | UB92 Print | Batch Print is in form |
| | | version. Can be aligned to |
| | | any printer. |
| | Well Woman Visit | Allows user to print a |
| | Reminder Letter (Not | reminder letter for an annual |
| | Formatted-Table View) | visit for female patients age |
| | | 18 and older. |
| | Well Woman Visit | To be printed in conjunction |
| | Reminder: Mailing | with the “Well Woman Visit |
| | Labels (Not Formatted- | Reminder Letter” on labels |
| | Table View) | 1″ × 2.62″. |
| | | EON SYSTEM Features |
| System Utilities | | Tools for the System |
| | | Administrator and |
| | | implementation and |
| | | maintenance |
| | Codes | Load & Maintain system Data |
| | | thru user interface direct to |
| | | database |
| | | EON provides, thru Partner, |
| | | updated CPT and ICD9 database |
| | | for coding schemes, HIPAA |
| | | compliant. |
| | | User can maintain all System |
| | | Codes without programming, |
| | | examples are: ICD9, CPT, |
| | | Adjustment and Payment Codes, |
| | | Account Status Codes and many |
| | | more. Over 200 code settings |
| | | available. |
| | Provider Billing Rates | Create and Maintain Unlimited |
| | Search Tool | Rate and Fee Schedules for |
| | | Billing, used by Encounters, |
| | | HFCA, Provider List Billing and |
| | | UB92 |
| | | Search by Procedure Code, |
| | | Facility, Provider, Contract, get |
| | | different Views, locate any |
| | | code/rate set |
| | Add/Maintain Rates | Load for Facility, any set of |
| | | rates for Procedure Codes |
| | | Load for a specific Provider |
| | | (single physician) his own set of |
| | | rates for anyone item |
| | | Load Rates with up to 4 |
| | | Modifiers so they can be priced |
| | | accordingly |
| | | Load rates by Contract for |
| | | Medicare, Managed Care Plans |
| | | Load by base rate x factor and |
| | | calculate amount automatically |
| | | Load by Effective and Term |
| | | Dates so pro-loading is easily |
| | | accommodated |
| | Pay Rates | Search by Procedure Code, |
| | | Facility, Provider, Contract, get |
| | | different Views, locate any |
| | | code/rate set |
| | | Load for Facility, any set of |
| | | Payment rates for Procedure |
| | | Codes |
| | | Load U&C |
| | | Load MDR |
| | | Load for a specific provider |
| | | (single physician) his own set of |
| | | rates for any one item |
| | | Load Rates with up to 4 |
| | | Modifiers so they can be priced |
| | | accordingly |
| | | Load by Account Code |
| | | Load rates by Contract for |
| | | Medicare, Managed Care Plans |
| | | Load by base rate x factor and |
| | | calculate amount automatically |
| | | Load by Effective and Term |
| | | Dates so pre-loading is easily |
| | | accommodated |
| | Accumulators | Convert Accumulations from |
| | | other databases, such as |
| | | balance forward |
| | | Enter accumulations by Plan and |
| | | Member, like deductibles or out- |
| | | of-pockets |
| | | Maintain Integrity of balances |
| | | and limits |
| | | Track occurrences, length, and |
| | | units |
| | | Track Monies and Expense |
| | | Limits |
| | | Account Balance |
| | | Account Charges |
| | | Payer Payments |
| | | patient payments |
| | | YTD Receipts |
| | | YTD Payments |
| | | Many More |
| | Table Browser | Direct user Interface allows you |
| | | to look at any EON object, |
| | | including queries, by searching |
| | | on object name or browsing all |
| | | by alphabetical list |
| | | View any Statistics from the |
| | | EON database. |
| | | Automatically search and sort |
| | | on any data element for slice |
| | | and dice views of data |
| | | Update record capability for |
| | | data management corrections |
| | | Maintain system settings and |
| | | perform tuning for |
| | | implementation, like electronic |
| | | billing parameters |
| | Cross Reference Data | Review and maintain all system |
| | | cross-referenced standard data |
| | | Add new items like new |
| | | procedure codes and their |
| | | Revenue Code Cross- |
| | | References |
| | | Add New Account Status Codes |
| | | and cross-ref to Billing |
| | | Parameters |
| | Admin Web Content | Change the look of your |
| | | applications by entering data |
| | | directly to the database with |
| | | easy to use screens, No |
| | | programming necessary, just |
| | | change and its real time display |
| | | adjustment. |
| | | Adjust the colors and Fonts for |
| | | the Patient Card |
| | | Change the display colors and |
| | | fonts of the Main Menu, |
| | | Including highlighting |
| | | Adjust Fonts and colors for |
| | | displays of application screens |
| | | and forms |
| | | Make changes per |
| | | schema/account, so that |
| | | multiple users from your site |
| | | may have a different look! |
| | | Adjust colors, fonts and styles |
| | | for your own private branding or |
| | | just for fun! |
| | | Add your company logo to the |
| | | main menu! Use any browser |
| | | compatible image. Create |
| | | holiday massages. |
| | | Change button graphics on the |
| | | application forms. |
| | Participant Content | Load content files for any |
| | Search View | participant in the MPI. File types |
| | | are anything supported by the |
| | | browser and database. Load |
| | | scanned images, PDFs, photos, |
| | | sound files etc. |
| | Add New/Update | Files can be downloaded from |
| | Content files for any | database, for distribution and |
| | Participant | management. |
| | Download Content from | Images supported by the |
| | Database | browser can be accessed and |
| | | displayed on line. |
| | Jobs Monitor History | On - Line view of all requested |
| | and Search View | Jobs, or background processes. |
| | Job Messages | Tracks errors and failures, |
| | | tracks users and logs times for |
| | | initiating and completing jobs. |
| | | User defined “refresh” cycle for |
| | | updates. |
| | | View Results and Statuses of |
| | | previous jobs. |
| | Security | Review and Manage Security |
| | Management | Rights for any person in the MPI |
| | | of a Security Type (personnel, |
| | | providers, and Security Users |
| | | are recommended) |
| | Codes/Levels | User can alter the standard level |
| | | arrangement, or add new levels |
| | | for customized security menus. |
| | User Profiles | Security profiles can have |
| | | access to multiple accounts |
| | | (data sets) with different levels |
| | | of access in each. |
| | User Accounts | Logons are transparent to the |
| | | user and can run thru multiple |
| | | web servers to multiple |
| | | databases and accounts. |
| | | Assign Logon Name, Password |
| | | Passwords have Effective and |
| | | Termination Date for pre-set |
| | | access. |
| | | Access Level dynamically |
| | | manages menu so the view suits |
| | | the user. |
| | | 10 Standard access levels |
| | | included in application, applied |
| | | to menus |
| | | User Defined Access Levels on a |
| | | vertical scale with endless |
| | | availability for adding new |
| | | levels |
| | User Password | Each user can logon only to his |
| | | or her profile and change their |
| | | own password. |
| | | Each Logon and each Log off is |
| | | recorded in the Log files and in |
| | | the database, by USER/Date and |
| | | Time stamp. |
| | | Each invalid attempt at logging |
| | | on is recorded as well. Anyone |
| | | who's trying to access the |
| | | system illegally would fall into |
| | | this record. |
| | Menus-Search View | Menus for EON applications are |
| | | dynamically created by the |
| | | combination of the menu |
| | | arrangement created in menus |
| | | and the logon level of the user. |
| | Add/Update Menu | Access all menu items in the list, |
| | Item | search by any menu data |
| | | element |
| | | Just click on one to access |
| | | details and update or alter menu |
| | | choices |
| | | Turn item off with one indicator |
| | | setting, changes are real time, |
| | | no rebooting or resetting. |
| | | Change the Order in which the |
| | | item appears in the menu. |
| | | Change the access level for |
| | | managing certain levels of users |
| | | actually seeing or using any |
| | | item. |
| | VPN Configuration | EON can be easily operated thru |
| | | a VPN from anywhere, for |
| | | secure transactions. |
| | | PKI can be used to further |
| | | encryption and complieswith |
| | | HIPAA standards |
| | Database/Log Files | All transactions are |
| | | USER/DATE/TIME stamped, and |
| | | recorded in the system log files. |
| | | This includes Views, Inserts, |
| | | Updates, Searches, and Deletes, |
| | | for HIPAA compliance. There's |
| | | actually a lot more, so if |
| | | something does look suspicious |
| | | in the reporting, you can track |
| | | every click the user made. |
| | | System log files, record all |
| | | system errors in excruciating |
| | | detail, so a system |
| | | administrator and The EON |
| | | Support team can easily track |
| | | bugs or issues you may have. |
| | | System Log Files are archived |
| | | each day at midnight, so you |
| | | can store and track all audit |
| | | trails. They also archive and |
| | | restart if you restart or reboot |
| | | the system. The customer can |
| | | choose when to archive and |
| | | purge these records, to monitor |
| | | these records. |
| | | Security transaction records are |
| | | recorded directly in the |
| | | database. This includes Views, |
| | | Inserts, Updates, Searches, and |
| | | Deletes, for HIPAA compliance. |
| | | The customer decides when to |
| | | archive and pruge the database |
| | | records. |
| | | All table record transactions, are |
| | | recorded with the last modified |
| | | user/date/time, transaction, |
| | | and results, in the record. |
| | Security Reporting | Reports by Date and User are |
| | | available for all transactions. |
| | | All Reports are run in the |
| | | background processing |
| | | programs. This allows |
| | | monitoring of all Report |
| | | Requests, and results by |
| | | User/Date/Time. |
| | | There is an on line Report Job |
| | | Monitor, displays the Report |
| | | that the user has requested, the |
| | | User Name, Date and Time |
| | | requested and Status. |
| | | The Reports Monitor only shows |
| | | the user the Jobs that he or she |
| | | has run, not the reports |
| | | requested by other users. |
| | | The Results of all Reports are |
| | | stored in the database, in the |
| | | appropriate formatted file. |
| | | Currently that includes HTML |
| | | and PDF files. |
| | | The system has separate log |
| | | files for each background |
| | | process job, run by the users. |
| | | You can find out what was |
| | | initiated and by whom, at any |
| | | time. |
| | | The on-line Jobs Monitor, |
| | | displays the job or process that |
| | | the user has requested, the User |
| | | Name, Date and Time requested |
| | | and Status. |
| | | The results of all jobs are stored |
| | | in the database, so the details of |
| | | each request can be monitored |
| | | as well. |
| | | Job Requests Reports are |
| | | available by User and Date |
| | | parameters. |
| | On-line Help System | Context sensitive pages display |
| | Context Sensitive Pop- | whatever the user is actually |
| | ups | working on, takes them straight |
| | | to details about the functions |
| | | and features. |
| | | Display is separate pop-up |
| | | window so the user can view |
| | | the documentation at the same |
| | | time as using the function. |
| | | All Pages are formatted to print |
| | | HTML |
| | Find - Search of all on- | Search Help allows searching |
| | line help and tutorial | thru on-line library with |
| | documents. | keywords for additional pages |
| | | and instructional topics. |
| | | EON provides complete User |
| | | Guide in four-color format with |
| | | picture oriented documentation, |
| | | in PDF format for printing and |
| | | reprinting on demand by User. |
| | Important Specification | This is a completely Web-based |
| | Features | server application set. There are |
| | | no legacy systems underneath |
| | | and no older architectures used. |
| | | EON is currently supported on |
| | | Windows 2000 as a server for |
| | | the web-applications. The |
| | | applications are a combination |
| | | of pure Java and database |
| | | objects, which enables it to run |
| | | across platforms easily. |
| | | Applications are currently |
| | | supported by Oracle 8.i |
| | | database, and Oracle can be run |
| | | on any Oracle compliant |
| | | operating system, Linux, Unix, |
| | | etc. EON can operate on other |
| | | JDBC compliant SQL relational |
| | | databases if client desires. |
| | | EON is currently supporting |
| | | Servlet-Exec 3.0 for the |
| | | application server or Tomcat, |
| | | which runs across platforms. |
| | | There is virtually no desktop |
| | | support necessary, beyond |
| | | monitoring the browser version |
| | | on the user's PC. There are no |
| | | downloaded ap[placations. |
| | | The desk-top can be anything |
| | | that can connect to the internet |
| | | and use Internet Explorer. |
| | | Including e-machines. See |
| | | hardware specs. |
| | | EON is ideal for Application |
| | | Service Provider (ASP) models, |
| | | as the economies of scale allow |
| | | cost of use per person to |
| | | decrease as users are added. |
| | | Objects and data |
| | | structures/content are designed |
| | | to be sharing configured by the |
| | | user. Physicians can share MPI |
| | | data, Patient demographics, or |
| | | not, as desired. |
| | | Updates, hot-fixes and Upgrades |
| | | are accomplished electronically. |
| | | The software exists in one file, |
| | | which can be sent thru VPN, FTP |
| | | or zipped up, and sent in e-mail. |
| | | Application of changes takes |
| | | only minutes. |
| | | EON Technologies, Inc. can |
| | | access your site thru VPN to |
| | | research issues or reported |
| | | bugs. |
| | | On-line training is available thru |
| | | Web-ex. No special |
| | | requirements for access |
| | | necessary. |

Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for providing interoperability between stakeholders in the healthcare industry, comprising:
a logically centralized database having information records related to a plurality of different stakeholders, wherein each stakeholder is a member of at least one category of stakeholders include at least a patient member, a medical provider and an insurance company;
a plurality of disparate medical records systems each provided by a different vendor and having different internal formats of data; and
at least one integration component interfaced with each of the plurality of disparate medical records systems to normalize the information in each disparate medical records system and to permit access to the normalized information by the different stakeholders.

2. The system of claim 1, wherein the normalized information is maintained in the logically centralized database.

3. The system of claim 1, wherein the medical provider includes at least one of: a pharmacy, a hospital, a clinic;

4. The system of claim 1, wherein the plurality of different stakeholders includes a financial institution or an employer.

4. The system of claim 1, further comprising a network for interconnecting the stakeholders and the logically centralized database.

5. The system of claim 1, further comprising a user interface to permit the different stakeholders access to the logically centralized database, wherein the user interface adapts in format and information content base on the category of stakeholder or identity of the stakeholder.

6. The system of claim 1, wherein the at least one interface component further provides communication with a back office, wherein the back office supports the plurality of disparate medical record systems.

7. The system of claim 6, wherein the back office provides at least any one of: aggregated clinical data, administrative functions and financial billing functions.

8. The system of claim 1, wherein the logically centralized database is substantially located in different geographical locations.

9. The system of claim 8, wherein the logically database is synchronized in real-time.

10. A method of providing interoperability for different types of stakeholders in the healthcare industry, the steps comprising:
identifying a type of stakeholder;
determining a need of the stakeholder;
identifying a software component to satisfy the need of the stakeholder based on the type of stakeholder;
integrating the identified software component with a medical records system associated with the stakeholder; and
exchanging data using the integrated software component by converting information in one format into a different format for access by another stakeholder to deliver a healthcare related transaction.

11. The method of claim 10, wherein the different types of stakeholders include at least any two of: a patient, a healthcare service provider, an employer, a pharmacy, a pharmaceutical company, a clearing house, a government that regulates insurers, an association, a union, a laboratory, financial institution and an insurance company.

12. The method of claim 10, wherein the type of stakeholder includes a specialist healthcare provider.

13. The method of claim 10, further comprising customizing an existing medical records system for the stakeholder in order to communicate information with other stakeholders.

14. The method of claim 10, wherein the healthcare related transaction comprises a clean claim for an insurance related transaction.

15. The method of claim 14, wherein the clean claim is verified for completeness and accuracy prior to submission to an insurance company.

16. A method for providing interoperability in the healthcare industry that includes a system comprising:
a logically centralized database having information records related to a plurality of different stakeholders, wherein each stakeholder is a member of at least one category of stakeholders include at least a patient member, a medical provider and an insurance company;
a plurality of disparate medical records systems each provided by a different vendor and having different internal formats of data;
at least one integration component interfaced with each of the plurality of disparate medical records systems to normalize the information in each disparate medical records system and to permit access to the normalized information by the different stakeholders; the method comprising the steps of:
querying the logically centralized database by a first stakeholder;
receiving a response from the centralized database that provides information concerning at least a second stakeholder; and
completing a healthcare related transaction based on the response.

17. The method of claim 16, wherein the healthcare related transaction comprises any one of a patient record update, a patient information lookup, a pharmaceutical patient outcome, a financial transaction, an insurance claim and a report based on aggregated data related to a plurality of patients.
